(19) United States
(12) Patent Application Publication
(10) Pub. No.: US 2019/0277618 A1
(43) Pub. Date: Sep. 12, 2019

(54) OBJECT ANALYSIS IN IMAGES USING ELECTRIC POTENTIALS AND ELECTRIC FIELDS

(71) Applicant: POLYVALOR, LIMITED PARTNERSHIP, Montreal (CA)

(72) Inventors: Dominique BEAINI, Laval (CA); Maxime RAISON, Montreal (CA); Soflane ACHICHE, Montreal (CA)

(21) Appl. No.: 16/331,208

(22) PCT Filed: Sep. 8, 2017
(86) PCT No.: PCT/CA2017/051062

§ 371 Date: Mar. 7, 2019

Related U.S. Application Data
(60) Provisional application No. 62/384,794, filed on Sep. 8, 2016.

(51) Int. Cl. G01B 7/28; G06T 5/20; G06T 7/64; G06T 7/11; G06T 7/136; G06T 7/143

(52) U.S. Cl. CPC G01B 7/28; G06T 5/20; G06T 7/143; G06T 7/11; G06T 7/136; G06T 7/64

(57) ABSTRACT

The present disclosure describes the use of electromagnetic (EM) potentials and fields in images for analyzing objects. Geometrical features may be detected based on electric and/or magnetic potentials and fields, and subsequently used for object grasping, defining contours, image segmentation, object detection, and the like.

### TECHNICAL FIELD

The present disclosure relates to systems and methods for image and shape analysis with different shapes in images, for applications such as object grasping, defining contours, image segmentation, object detection, contour completion, and the like.

### BACKGROUND OF THE ART

Although various aspects of vision come naturally to humans, including object differentiation, object permanence, spatial positioning, and the like, providing computers or robots with the same abilities is difficult. Approaches to automating image analysis have seen strides in recent years, but many challenges still exist, including proper object recognition and differentiation, which may be based on determining the contour of objects.

The difficulties in automated image analysis also pose a challenge for the development of industrial or domestic robots, for example in relation to their capability to grasp different objects present in their working environment. These capabilities allow the robot to fully interact with its surroundings and to accomplish far more complex and less repetitive tasks. It will also give the robot the ability to adapt to new environments and to be used for multiple tasks. Furthermore, being able to grasp unknown and complex objects will improve the robot's ability to collaborate with humans by allowing it to provide better assistance.

However, there are arguably an infinite number of possible images and shapes, which makes it hard to develop an automated solution. Also, for the case of object grasping, robot hands (end effectors) can have multiple fingers, which also leads to an infinite number of possible hand configurations. Therefore, the difficulty is to find optimal and stable grasping points, no matter the number of fingers, the shape or the size of the object.

There is therefore a need to address the problem of contour completion and object grasping.

### SUMMARY

The present disclosure describes the use of electromagnetic (EM) potentials and fields in images for analyzing objects. Geometrical features may be detected and subsequently used for object grasping, defining contours, contour completion, image segmentation, object detection, and the like.

In accordance with a broad aspect, there is provided a method for analyzing a shape of an object in an image, the method comprising: obtaining an image comprising an object; convoluting the image with a kernel matrix of electric potentials to obtain a total potential image, each matrix element in the kernel matrix having a value corresponding to |r|²⁻ⁿ, for n≠2 and ln|r| for n=2, where r is a Euclidean distance between a center of the kernel matrix and the matrix element, and n is a number of virtual spatial dimensions, the total potential image resulting from the convolution and having electric potential values at each pixel position; calculating electric field values of each pixel position from the electric potential values; and identifying features of the object based on the electric field values and the electric potential values.

In some embodiments, the method further comprises representing each pixel position in the image with a density of charge value.

In some embodiments, calculating the electric field values comprises calculating horizontal electric field values and vertical electric field values, and determining normalized electric field and direction values from the horizontal electric field values and vertical electric field values.

In some embodiments, the kernel matrix has a size of (2N+1) by (2M+1), where N and M are a length and a width of the image, respectively.

In some embodiments, calculating electric field values comprises determining a gradient for each pixel position of the total potential image.

In some embodiments, identifying features of the object based on the electric field values and the electric potential values comprises comparing the electric field values to the electric potential values and determining at least one of the features based on the comparing.

In some embodiments, identifying features of the object comprises identifying a shape of at least one region of the object.

In some embodiments, identifying a shape comprises determining whether the at least one region is substantially concave, convex, or flat.

In some embodiments, identifying features of the object comprises identifying a contour of the object.

In some embodiments, the features of the object are one of two-dimensional and three-dimensional features.

In accordance with another broad aspect, there is provided a system for analyzing a shape of an object in an image, the system comprising a processing unit; and a non-transitory computer-readable memory having stored thereon program instructions executable by the processing unit for: obtaining an image comprising an object; convoluting the image with a kernel matrix of electric potentials to obtain a total potential image, each matrix element in the kernel matrix having a value corresponding to |r|²⁻ⁿ, for n≠2 and ln|r| for n=2, where r is a Euclidean distance between a center of the kernel matrix and the matrix element, and n is a number of virtual spatial dimensions, the total potential image resulting from the convolution and having electric potential values at each pixel position; calculating electric field values of each pixel position from the electric potential values; and identifying features of the object based on the electric field values and the electric potential values.

In some embodiments, the program instructions are further executable for representing each pixel position in the image with a density of charge value.

In some embodiments, calculating the electric field values comprises calculating horizontal electric field values and vertical electric field values, and determining normalized electric field and direction values from the horizontal electric field values and vertical electric field values.

In some embodiments, the kernel matrix has a size of (2N+1) by (2M+1), where N and M are a length and a width of the image, respectively.

In some embodiments, calculating electric field values comprises determining a gradient for each pixel position of the total potential image.

In some embodiments, identifying features of the object based on the electric field values and the electric potential values comprises comparing the electric field values to the electric potential values and determining at least one of the features based on the comparing.

In some embodiments, identifying features of the object comprises identifying a shape of at least one region of the object.

In some embodiments, identifying a shape comprises determining whether the at least one region is substantially concave, convex, or flat.

In some embodiments, identifying features of the object comprises identifying a contour of the object.

In some embodiments, the features of the object are one of two-dimensional and three-dimensional features.

In accordance with a further broad aspect, there is provided a method for determining at least two grasping points for an object, the method comprising: defining at least one contour for the object; calculating electric potentials of pixels inside the at least one contour; calculating electric fields of pixels inside the at least one contour; selecting a first region of highest electric potential on the at least one contour as a thumb region; and selecting at least one second region of highest electric potential or highest electric field on the at least one contour as at least one secondary region.

In some embodiments, selecting a first region comprises: applying at least one threshold value to the electric potentials along the at least one contour to obtain regions of interest; uniting nearby pixels in the regions of interest into united regions; and selecting from the united regions a region having a greatest number of pixels as the thumb region.

In some embodiments, the method further comprises calculating magnetic potentials of pixels in the at least one second region; and selecting at least one third region from the at least one second region as a region of highest magnetic potential for positioning at least one finger.

In some embodiments, the method further comprises identifying at least one inner handle region by applying an electric field threshold and an electric potential threshold to the electric fields and the electric potentials, respectively, along the at least one contour.

In some embodiments, the method further comprises calculating magnetic potentials of pixels along the at least one contour; applying a magnetic field threshold to the magnetic potentials to obtain regions of interest; uniting pixels in the regions of interest into united regions; and selecting from the united regions a region having a greatest number of pixels as an outer handle region.

In some embodiments, the method further comprises identifying thin regions by: applying an electric field threshold and an electric potential threshold to the electric fields and the electric potentials, respectively, along the at least one contour; calculating magnetic potentials of pixels along the at least one contour; applying a magnetic field threshold to the magnetic potentials to obtain regions of interest; uniting pixels in the regions of interest into united regions; and confirming the at least one first thin region when a region from the united regions having a greatest number of pixels is coincident with the at least one thin region.

In some embodiments, the method further comprises applying a function to the electric potentials to define a preferred grasping direction.

In some embodiments, defining at least one contour for the object comprises: defining at least one partial contour for the object, the at least one partial contour being associated with a gradient which exceeds a predetermined gradient threshold; and completing the at least one partial contour with at least one additional contour portion.

In some embodiments, completing the at least one partial contour comprises probabilistically determining the curvature of the at least one additional contour portion.

In some embodiments, probabilistically determining the curvature of the at least one additional contour portion comprises: determining a first probability that a first point on a first side of the additional contour portion is located within an interior of the contour; determining a second probability that a second point substantially opposite the first point on a second side of the additional contour portion is located within the interior of the contour; and determining the curvature of the at least one additional contour portion based on the first probability and the second probability.

In accordance with another broad aspect, there is provided a system for determining at least two grasping points for an object, the system comprising a processing unit; and a non-transitory computer-readable memory having stored thereon program instructions executable by the processing unit for: defining at least one contour for the object; calculating electric potentials of pixels inside the at least one contour; calculating electric fields of pixels inside the at least one contour; selecting a first region of highest electric potential on the at least one contour as a thumb region; and selecting at least one second region of highest electric potential or highest electric field on the at least one contour as at least one secondary region.

In some embodiments, selecting a first region comprises: applying at least one threshold value to the electric potentials along the at least one contour to obtain regions of interest; uniting nearby pixels in the regions of interest into united regions; and selecting from the united regions a region having a greatest number of pixels as the thumb region.

In some embodiments, the program instructions are further executable for: calculating magnetic potentials of pixels in the at least one second region; and selecting at least one third region from the at least one second region as a region of highest magnetic potential for positioning at least one finger.

In some embodiments, the program instructions are further executable for identifying at least one inner handle region by applying an electric field threshold and an electric potential threshold to the electric fields and the electric potentials, respectively, along the at least one contour.

In some embodiments, the program instructions are further executable for: calculating magnetic potentials of pixels along the at least one contour; applying a magnetic field threshold to the magnetic potentials to obtain regions of interest; uniting pixels in the regions of interest into united regions; and selecting from the united regions a region having a greatest number of pixels as an outer handle region.

In some embodiments, the program instructions are further executable for identifying thin regions by: applying an electric field threshold and an electric potential threshold to the electric fields and the electric potentials, respectively, along the at least one contour; calculating magnetic potentials of pixels along the at least one contour; applying a magnetic field threshold to the magnetic potentials to obtain regions of interest; uniting pixels in the regions of interest into united regions; and confirming the at least one first thin region when a region from the united regions having a greatest number of pixels is coincident with the at least one thin region.

In some embodiments, the program instructions are further executable for applying a function to the electric potentials to define a preferred grasping direction.

In some embodiments, defining at least one contour for the object comprises: defining at least one partial contour for the object, the at least one partial contour being associated with a gradient which exceeds a predetermined gradient threshold; and completing the at least one partial contour with at least one additional contour portion.

In some embodiments, completing the at least one partial contour comprises probabilistically determining the curvature of the at least one additional contour portion.

In some embodiments, probabilistically determining the curvature of the at least one additional contour portion comprises: determining a first probability that a first point on a first side of the additional contour portion is located within an interior of the contour; determining a second probability that a second point substantially opposite the first point on a second side of the additional contour portion is located within the interior of the contour; and determining the curvature of the at least one additional contour portion based on the first probability and the second probability.

Table 1 below provides the nomenclature used in the present disclosure.

TABLE 1

| | |
|---|---|
| e, m | Electric (e) or Magnetic (m) |
| dip | Dipole |
| onC | Only values on the contour |
| onR | Only values on the regions of interests |
| I | Image matrix, with values between −1 and +1 |
| C | Contour matrix, C = 1 on the contour, C = 0 elsewhere |
| E_{e,m} | Virtual Vector field [V⁰ pix⁻¹] |
| V_{e,m} | Virtual Potential [V⁰] |
| P_{e,m,dip} | Virtual Potential kernel of a monopole or dipole [V⁰] |
| q_{e,m} | Virtual Charge |
| r | Virtual distance from an electric charge [pix] |
| n | Number of spatial dimensions for the virtual potential |
| P_{pref} | Potential of a preferential direction [V⁰] |
| θ_{pref} | Orientation of the preferential direction |
| α | Weight factor for the preferential direction |
| δ^{x,y} | Numerical derivative kernel in \hat{x} or ŷ direction [pix⁻¹] |
| ε_{e,m} | Vector field [N C⁻¹]ₑ, [N A⁻¹m⁻¹]ₘ |
| V_{e,m} | Potential [V]ₑ, [V s m⁻¹]ₘ |
| ∇ | Gradient operator |
| ∇ · | Divergence operator |
| ∇ X | Curl operator |
| * | Convolution operator |
| ∘ | Hadamard product (Element-wise multiplication) |

### BRIEF DESCRIPTION OF THE DRAWINGS

Further features and advantages of the present invention will become apparent from the following detailed description, taken in combination with the appended drawings, in which:

FIG. 1 is a flowchart of an example method for analyzing an object in an image;

FIG. 2 illustrates static electric potential and filed of a positive monopole (FIG. 2A) and a negative monopole (FIG. 2B);

FIG. 3 illustrates electric potential and field for static monopoles placed as: (a) a simple dipole, (b) a small chain of simple dipoles, (c) a horizontal and a vertical dipole, equivalent as 2 dipoles at 45°, (d) a long chain of simple dipoles, and (e) simple dipoles in parallel;

FIG. 4 illustrates potential and field with n=3 for positive monopoles placed on (a) A circle, and (b) A corner;

FIG. 5 illustrates an example of convolution kernel for a particle potential matrix Pₑ of size 7×7: (a) Euclidian distance from center r, and (b) Potential of a centered monopole Pₑ=Vₑ,n=3;

FIG. 6 illustrates steps to calculate the normalized potential kernel for a dipole: (a) Positive and negative monopoles at 1 pixel distance, (b) Potential kernel Pₑ, and (c) Dipole potential kernel P_{dip}^{x} resulting from the convolution of image “a” with kernel “b”;

FIG. 7 shows an example calculation of the potential and field of an image: (a) Monopoles in the image, (b) Potential kernel Pₑ, (c) Total potential Vₑ, (d) Horizontal field Eₑ^{x}, (e) Vertical field Eₑ^{y}, and (f) Field norm |Eₑ| and direction;

FIG. 8 shows steps to calculate the potential and field of an image: (a) Dipoles in the image, (b) Horizontal dipole potential kernel Pₘ^{x}, (c) Total potential Vₘ, (d) Horizontal field Eₘ^{x}, (e) Vertical field Eₘ^{y}, and (f) Field norm |Eₘ| and direction;

FIG. 9 shows example analyses of three-dimensional shapes using EM potential V and field E, with different values of n: (a) V_{onC}² with n=3, (b) |E|²_{onC} with n=3, (c) V_{onC}² with n=4, (d) |E|²_{onC} with n=4;

FIG. 10 shows magnetic potentials for an example stroke: (a) the example stroke, (b) magnetic potential with n=3, (c) magnetic potential with n=2, (d) the example stroke at higher resolution, (e) magnetic potential with n=3 at higher resolution, and (f) magnetic potential with n=2 at higher resolution;

FIG. 11 shows potentials Vₘ of an example circular strokes magnetized perpendicular to their respective orientations: Circle arc of 90° with n=2, (b) Circle arc of 270°, with n=2, (c) Circle arc of 360°, with n=2, (d) Circle arc of 90° with n=3, (e) Circle arc of 270°, with n=3, (f) Circle arc of 360°, with n=3;

FIG. 12 shows magnetic attraction and repulsion interactions for example strokes: (a) example strokes, (b) attraction potential Vₘ, (c) repulsion potential Vₘ, (d) attraction field |Eₘ|, (e) repulsion field |Eₘ|;

FIG. 13 shows perpendicular-dipole-based potentials Vₘ for example strokes: (a) clean stroke, (b) clean stroke potential V_{dip}⁰, (c) clean stroke potential |V_{dip}⁰|², (d) deformed stroke, (e) deformed stroke potential V_{dip}⁰, (f) deformed stroke potential |V_{dip}⁰|², (g) heavily-distorted stroke, (h) heavily-distorted stroke potential V_{dip}⁰, (i) heavily-distorted stroke potential |V_{dip}⁰|²;

FIG. 14 shows positive and negative regions produced by perpendicular magnetization of an example stroke;

FIG. 15 shows an example stroke S;

FIG. 16 shows example probabilities for an example stroke S;

FIG. 17 shows an example repulsion process for example partial contours: (a) the example partial contours, (b) an initial potential Vₘ, (c) the potential Vₘ after repulsion maximization;

FIG. 18 shows results of an example iterative repulsion process: (a) an example image, (b) a gradient of the image, (c) a low-threshold gradient thresholding, (d) a partial contour via high-threshold gradient thresholding, (e) to (i) iterations of completing the partial contour, (j) the completed contour;

FIG. 19 shows results of the iterative repulsion process applied to an example complex image;

FIG. 20 is a flowchart of an example method for determining at least two positions on an object for grasping;

FIG. 21 shows contour region manipulation: (a) Original region, (b) United region UR with a growth of 1.5% BL of (a), (c) Growth of 6% BL of the UR, and (d) Shortening of 6% BL of the UR;

FIG. 22 shows the regions of interest found on a complex shape using a contour analysis by potential and field thresholds. (a) Concave regions, (b) Convex regions, (c) Flat regions, (d) Regions near the CM, (e) Regions far from the CM, (f) Regions inside the shape;

FIG. 23 shows the regions of interest found on a complex shape (filtered with twirl, twist and wave noise) using a contour analysis by potential and field thresholds. (a) Concave regions, (b) Convex regions, (c) Flat regions, (d) Regions near the CM, (e) Regions far from the CM, (f) Regions inside the shape;

FIG. 24 is an example process of how to determine the potential and field of an object, and only keep the contour values;

FIG. 25 is an example process of how to determine the regions of interests of an object;

FIG. 26 is an example process of how to determine the fingers opposed to the thumb by magnetizing the thumb region;

FIG. 27 is an example algorithm used to determine the exact location of the fingers from Vₘ^{onR};

FIG. 28 is an example process of how to determine the opposite side of the handle from the inside region;

FIG. 29 illustrates an example comparison between (a) The handles of a mug and (b) The thin region of a badminton racquet;

FIG. 30 shows an example application of a preferential potential on a mug with α=0.5 and θ_{pref}=180°;

FIG. 31 is a legend used to present the results in FIGS. 19 to 26;

FIG. 32 shows results of five finger grasping for six simple shapes: (a) A circle, (b) A hexagon, (c) A square, (d) An equilateral triangle, (e) A 5-point star, and (f) A rectangle;

FIG. 33 shows results of five finger grasping for six complex shapes: (a) A curved corner square, (b) An “L” shape, (c) A grid, (d) Multiple crosses, (e) A cone, and (f) A Koch snowflake fractal;

FIG. 34 shows results of five finger grasping for twelve objects: (a) A banana. (b) A mug. (c) A knife. (d) A bag. (e) A key. (f) A wine glass. (g) A ping-pong racquet. (h) An American football. (i) A badminton racquet. (j) A bow. (k) A soda glass. (I) A pineapple;

FIG. 35 shows results of five finger grasping for six mugs subjected to transformations or distortions: (a) Original image. (b) 45° rotation; (c) size reduction with 16 times less pixels. (d) Perspective distortion. (e) Wave, zig-zag and twirl distortion. (f) twirl and spherical distortion, with shortened handle;

FIG. 36 shows results for the mug: (a) without preferential direction. (b) with preferential direction α=0.5 and θ_{pref}=180°;

FIG. 37 presents a comparison between: (a) Curvature maximization with an EFD of 4 harmonics [4], (b) Curvature maximization with and EFD of 32 harmonics, (c) the present method;

FIG. 38 presents a comparison for the grasping of a wine glass between: (a) Best state of hand posture after 29,000 iterations, (b) Best state of hand posture after 70,000 iterations, (c) the present method on the same wine glass, and (d) the present method on a different wine glass.

FIG. 39 presents a comparison for the grasping of objects from their inside between: (a) Best results for deep learning, (b) the present method on the same object without holes, and (c) the present method on the same object with holes.

FIGS. 40A-B are examples of using electromagnetic properties for defining contours;

FIG. 41 is an example of the magnetic potential of an image;

FIG. 42 is an example of contour definition based on the magnetic potentials in FIG. 28;

FIGS. 43A-C are examples showing image segmentation using electromagnetic properties;

FIGS. 44A-B are examples showing image segmentation using electromagnetic properties, based on colors and textures in an image;

FIG. 45 is an example system for object analysis in images; and

FIG. 46 is an example implementation of the image processor of FIG. 45.

It will be noted that throughout the appended drawings, like features are identified by like reference numerals.

### DETAILED DESCRIPTION

There are described herein methods and systems for computer vision. By analyzing the potentials and fields of images and by determining the attraction or repulsion, local and/or global characteristics of shapes in the images are obtained. The image may be of any resolution, and may have been obtained using various image sensors, such as but not limited to cameras, scanners, and the like. Images of simple and/or complex shapes are analyzed in order to identify geometric features therein, such as concave, convex, and flat regions, inner and outer regions, and regions that are proximate or distant from a center of mass of an object in the image. The use of electric potentials and fields for image analysis may be applied in various applications, such as object grasping, contour defining, image segmentation, object detection, and the like.

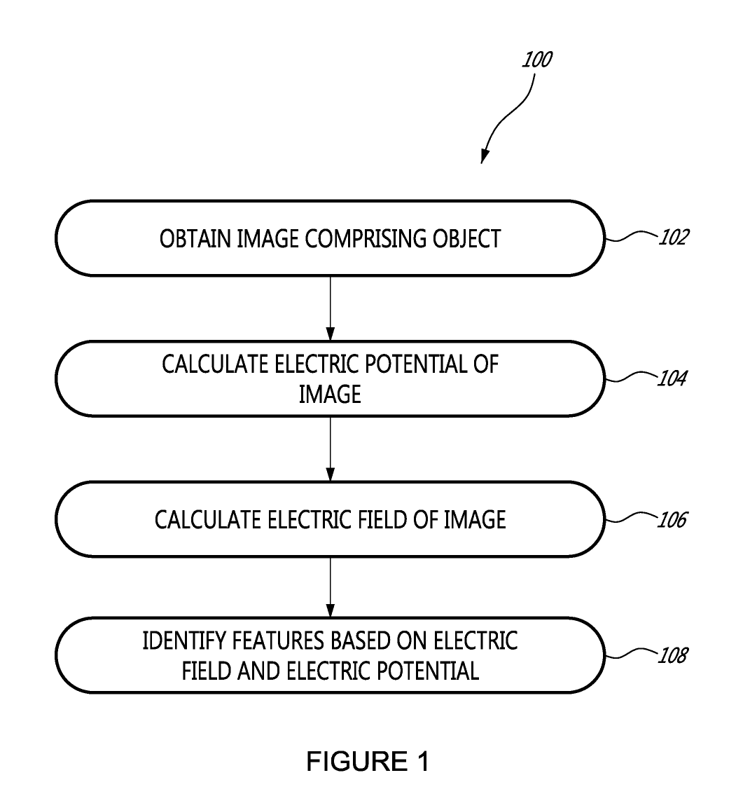

An example embodiment of a method for analyzing an object in an image is presented in FIG. 1. At step 102 of the method 100, an image is obtained. In some embodiments, the image is obtained by retrieving a stored image from a memory, either remotely or locally. Alternatively, the image may be received directly. Also alternatively, obtaining the image comprises acquiring the image using one or more image acquisition devices.

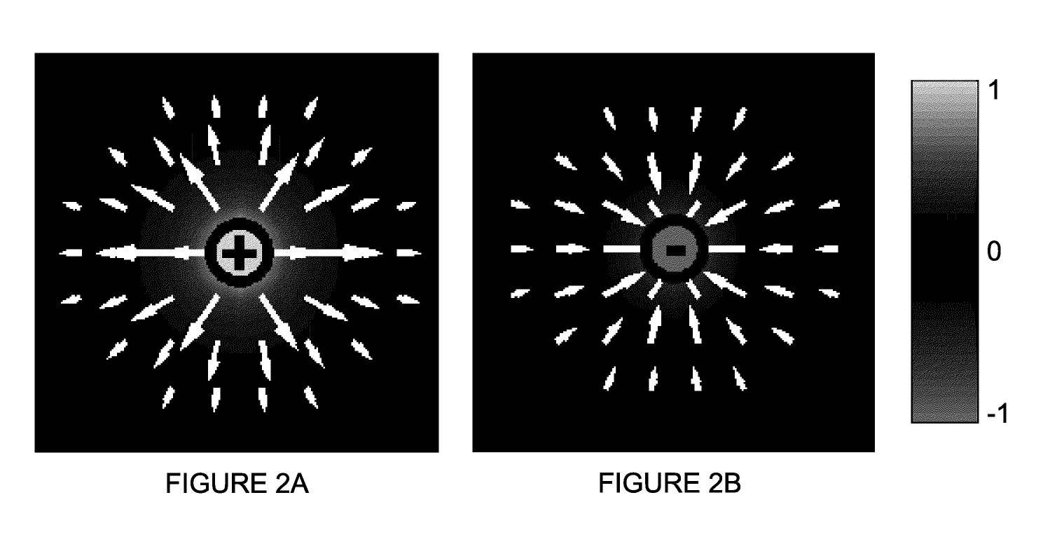

At step 104, the electric potential of the image is calculated and at step 106, the electric field of the image is calculated. At step 108, features of the objects in the image are identified based on the electric field and/or the electric potential of the image. These steps are explained in more detail below with reference to FIGS. 2 to 8.

Certain pixels of an image are considered as monopoles or dipoles so as to determine the electromagnetism (EM) potential or field of an image with a convolution. Static electric monopoles are the most primitive elements that generate an electrical field, and they can be positive or negative. The positive charges generate an outgoing electric field and a positive potential, while the negative charges generate an ingoing electric field and a negative potential. This is shown in FIGS. 2A and 2B, where the color scale is the normalized value of the electric potential Vₑ and the arrows represent the electric field ϵₑ. In a three-dimensional (3D) universe, the values of the potentials and fields of static charges are given by equations (1):

$${v}_{e} = \frac{{q}_{e}}{4 {πɛ}_{0} ‖ r ‖} \\ {ɛ}_{e} = \frac{{q}_{e}}{4 {πɛ}_{0} {‖ r ‖}^{2}} \hat{r} \qquad ( 1 )$$

Note that the present disclosure is not limited to the 3D equations of electromagnetism and more general equations are presented.

The color-bar used for the potential and shown in FIGS. 2A and 2B is normalized so that the value “1” is associated with the maximum potential and “−1” is associated with the maximum negative potential. When more than one particle is considered, the total potential and field is the sum of all the individual potentials and fields, as given by equation (2). It should be noted that the total potential is a simple scalar sum, while the total field is a vector sum.

$${v}_{e}^{tot} = {\sum }_{i}^{n} {v}_{e}^{i} , {ɛ}_{e}^{tot} = {\sum }_{i}^{n} {ɛ}_{e}^{i} \qquad ( 2 )$$

An electric dipole is created by placing a positive charge near a negative charge. This generates an electric potential that is positive on one side (positive pole), negative on the other side (negative pole) and null in the middle. The charge separation dₑ is a vector corresponding to the displacement from the positive charge to the negative charge, and is mathematically defined at equation (3):

dₑ=rₑ₊−rₑ₋ (3)

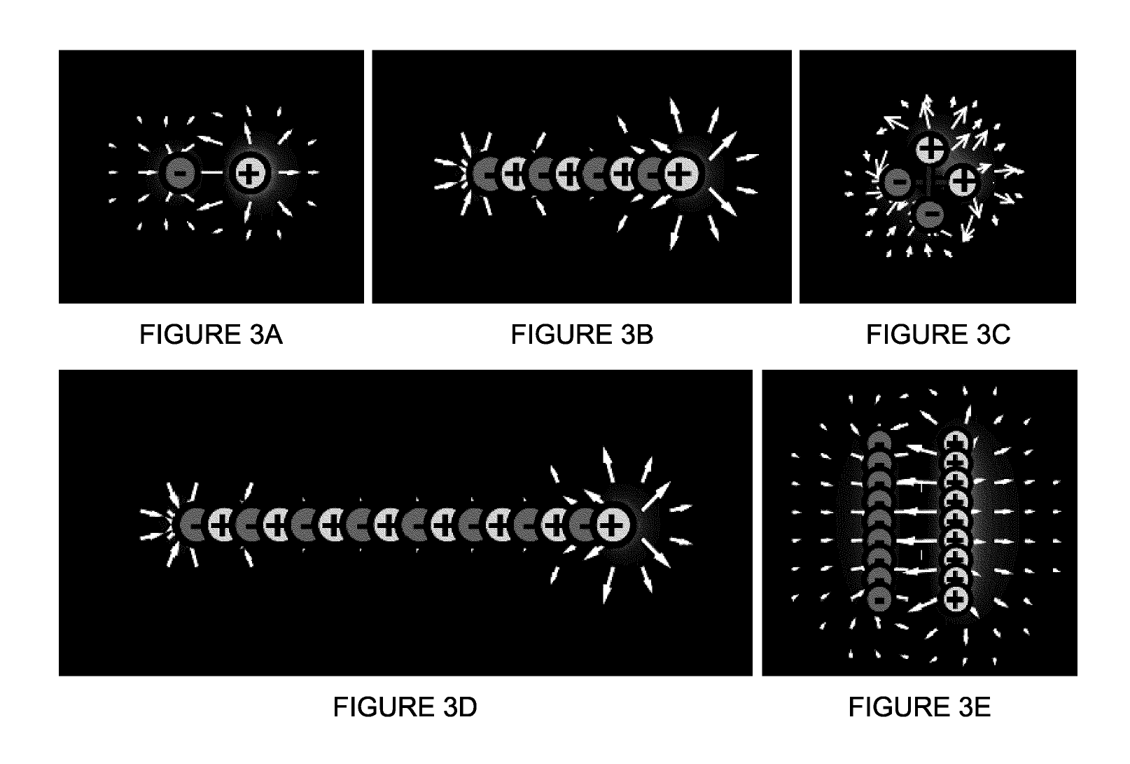

The electric field will then have a preferential direction along the vector dₑ by moving away from the positive charge, but it will loop back on the sides to reach the negative charge. Many examples of electric dipoles are presented at FIGS. 3A-3E, with the simplest form being composed of 2 opposite charges. From FIGS. 3A-3E, it can be seen that stacking multiple dipoles in a chain will not result in a stronger dipole, because all the positive and negative charges in the middle will cancel each other out. Therefore, stacking the dipoles in series will only place the poles further away from each other. However, stacking the dipoles in parallel will result in a stronger potential and field on each side of the dipole. It is also possible to see that the field will be almost perpendicular to the line of parallel dipoles, but it is an outgoing field on one side and an ingoing field on the other.

To calculate the total electric potential and field of any kind of dipole, it is possible to use equations (1), while changing the sign of qₑ accordingly. This sign change leads to a potential that diminishes a lot faster for dipoles at FIGS. 3A-3E when compared to the monopoles at FIGS. 2A-2B. In a 3D world, with θ=0 alongside vector dₑ, the dipole potential will vary according to V_{dip}\tilde{∝} cos(θ)/∥r∥², compared to the monopole potential which varies in proportion to Vₑ∝1/∥r∥.

Another aspect of dipoles is that when dₑ is small, the potential of a diagonal dipole is calculated by the linear combination of a horizontal and a vertical dipole. The potential of a dipole at angle θ(V_{dip}^{θ}) is approximated by equation (4). This may be proven by using the statement that V_{dip}∝cos(θ).

V_{dip}^{θ}≈V_{dip}^{x} cos(θ)+V_{dip}^{y} sin(θ) (4)

The superscripts x,y denote the horizontal and vertical orientation of the dipoles. A visual of this superposition is given at FIG. 3C, where it is shown that a horizontal dipole with a vertical dipole is equivalent to two dipoles placed at 45°.

Electricity and magnetism are two concepts with an almost perfect symmetry between them, and will lead to similar mathematical equations. First of all, a magnetic dipole is what is commonly called a “magnet”, and is composed of a north pole (N) and a south pole (S). When compared to the electrical dipole, the north pole is mathematically identical to the positive pole and the south pole is identical to the negative pole. Therefore, the potentials and fields of magnetic dipoles are identical to those of FIGS. 3A-3E, and the equations are the same as those defined by equation (4), except for the constants.

One can also mathematically define a magnetic monopole the same way as the electric monopole was defined. Although magnetic monopoles are not found in nature, their mathematical concepts may be used for computer vision.

In order to use the laws of EM, they are adapted for computer vision by removing some of the physical constraints and by ignoring the universal constants. Maxwell's equations are simplified using the assumption that all charges are static and that magnetic monopoles can exist. This allows to generalize the potential and field equations in a universe with n spatial dimensions, where n is not necessarily an integer. The modified field is presented at equation (5).

$${E}_{e , m} = {q}_{e , m} \frac{\hat{r}}{{\vert r \vert}^{n - 1}} , n ∈ {+}^{} \& n \geq 1 \qquad ( 5 )$$

By using electromagnetic laws, the relationship between the potential V and it's gradient E may be written as equation (6):

E_{e,m}=−∇V_{e,m}

V_{e,m}=−∫_{C}E_{e,m}·dl (6)

It is then possible to determine the potential, as per step 104, by calculating the line integral of equation (5). This leads to equation (7), where we purposely omit all the integral constants, the other constant terms that depends of n.

$${V}_{e , m} ∝ \{ \begin{matrix}{q}_{e , m} {\vert r \vert}^{2 - n} , 1 \leq n < 2 \\ {q}_{e , m} \cdot ln \vert r \vert , n = 2 \\ \frac{{q}_{e , m}}{{\vert r \vert}^{n - 2}} , n > 2\end{matrix} \qquad ( 7 )$$

For n=3, V_{e,m}∝|r|⁻¹,, which is identical to the real electric potential in 3D. Because the field is the gradient of the potential, then the vector field will always be perpendicular to the equipotential lines, and its value will be greater when the equipotential lines are closer to each other. The electric field may be found as the gradient of the electric potential, as per step 106.

For the purpose of the present disclosure, the term “electric” is used when using monopoles and “magnetic” or “magnetize” when using dipoles.

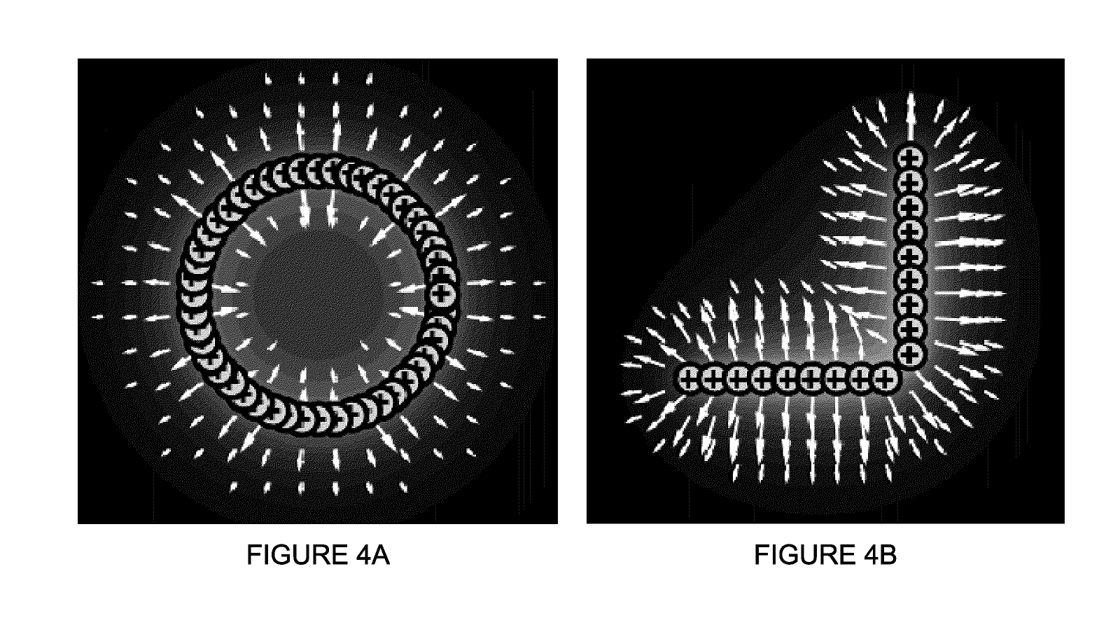

If a given shape is filled of positive electric monopoles, then the field will tend to cancel itself near the center of mass (CM) or in concave regions. However, the potential is scalar, which means that it will be higher near the CM or in concave regions. This difference in the behavior of the potential and the field is observed in FIGS. 4A and 4B. Using this difference, we can determine the features of the shape in a given region depending only on the values of Vₑ or |Eₑ|, as per step 108. The characteristics of the potential and the field in different regions of the shape are summarized in Table II. A combination of these factors is also possible, for example a concave region near the CM, which yields to a really high potential and a slightly low field.

TABLE II

Characteristics

| Shape of Region | Vₑ | \|Eₑ\| |
|---|---|---|
| Concave | High | Low |
| Convex | Slightly low | Slightly Low |
| Flat | Average | High |
| Near CM | High | Average |
| Far from CM | Low | Low |
| Inside | Very High | Very High |

The potential is first calculated using equation (7) because it represents a scalar, which means the contribution of every monopole may be summed by using two-dimensional (2D) convolutions. Then, the vector field is calculated from the gradient of the potential. Convolutions are used because they are fast to compute due to the optimized code in some specialized libraries such as Matlab® or OpenCV®.

Knowing that the total image potential is calculated from a convolution, the potential of a single particle is manually created on a discrete grid or matrix. The matrix is composed of an odd number of elements, which allows us to have one pixel that represents the center of the matrix. If the size of the image is N×M, Pₑ may be used as a matrix of size (2N+1)×(2M+1). This avoids having discontinuities in the derivative of the potential. However, it means that the width and height of the matrix can be of a few hundred elements. Of course, other matrix sizes are also considered, for example (4N+1)×(4M+1), or even matrices which are not of odd size.

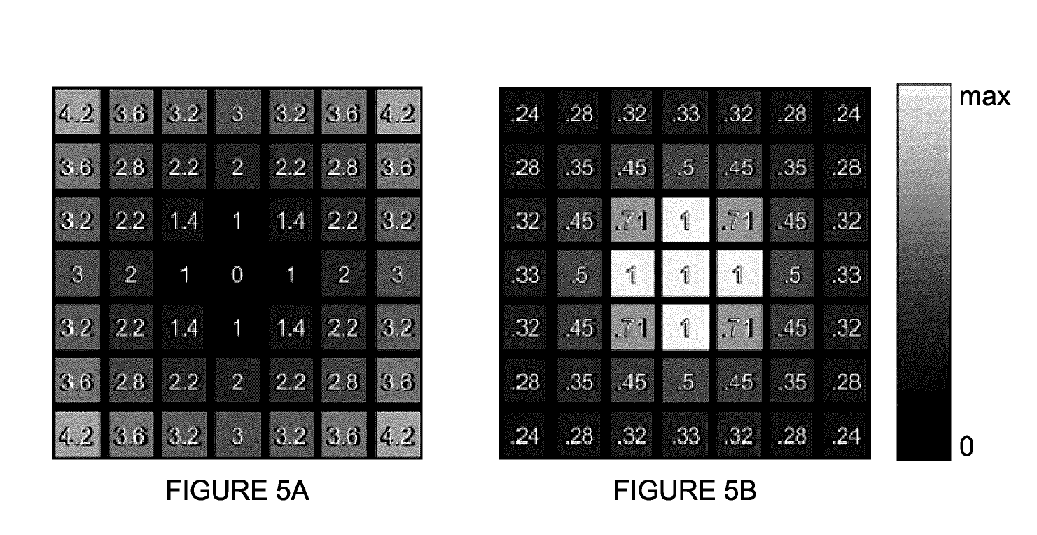

The convolution kernel matrix for Pₑis calculated the same way as Vₑ at equation (7), because it is the potential of a single charged particle, with the distance r being the Euclidean distance between the middle of the matrix and the current matrix element. An example of a Pₑ matrix of size 7×7 is illustrated in FIGS. 5A and 5B, where it is noted that Pₑ is forced to 0 at the center.

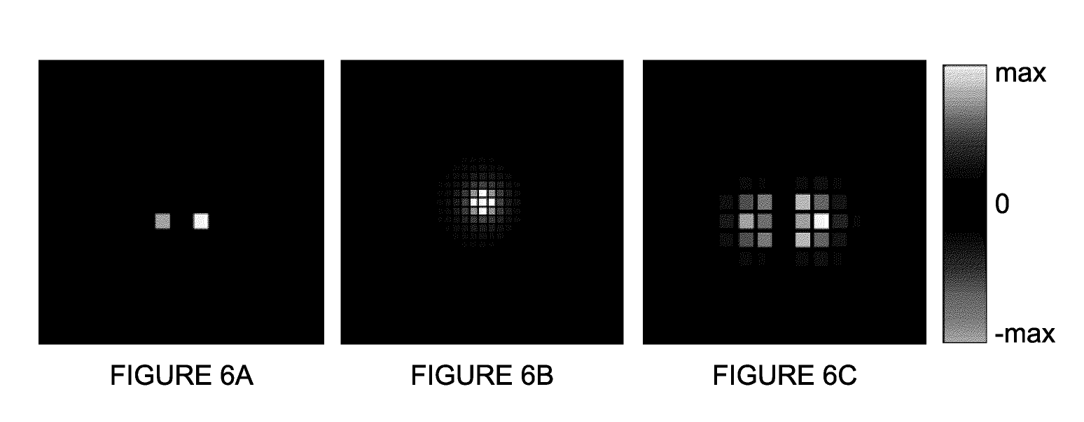

Convolutions with dipole potentials are also used to create an anti-symmetric potential and find the specific position of a point. Therefore, a potential convolution kernel may be created for a dipole P_{dip}. A dipole is two opposite monopoles at a small distance from each other. First, a square zero matrix is created with an odd number of elements, for example the same size as Pₑ. Then, the pixel on the left of the center is set to −1, and the pixel on the right is set to +1. Mathematically, P_{dip} is given by equation (8), and is visually shown in FIGS. 6A-6C. If divided by a factor of two, this convolution is similar to a horizontal numerical derivative (shown below at equations (10) and (11)), meaning that the dipole potential is twice the derivative of the monopole potential.

P_{dip}^{x}=Pₑ*[−1 0 1],P_{dip}^{y}=−(P_{dip}^{x})^{t}

size(P_{dip})=size(Pₑ) (8)

Using equation (4) along with equation (8), it is possible to determine equation (9), which gives the dipole kernel at any angle θ.

P_{dip}^{θ}≈P_{dip}^{x} cos(θ)+P_{dip}^{y} sin(θ) (9)

Derivative kernels are used to calculate the field because it is shown above in equation (6) that the field kₘ, is the gradient of the potentials V_{e,m}. To use the numerical central derivatives, the convolution given at equation (10) is applied, with the central finite difference coefficients given at equation (11) for an order of accuracy (OA) of value 2. However, other OA can be used depending on the needs.

$$\begin{matrix}\frac{df}{dx} \approx f * {δ}^{x} , \frac{df}{dy} \approx f * {δ}^{y} & ( 10 ) \\ {δ}^{x} = {( {δ}^{y} )}^{T} = \frac{1}{2} [ \begin{matrix}- 1 & 0 & 1\end{matrix} ] , OA = 2 & ( 11 )\end{matrix}$$

In some embodiments, the method 100 also comprises a step of transforming an image into charged particles, which will allow calculating the electric potential and electric field, as per steps 104 and 106. To do so, the position and intensity of the charge is determined. Each pixel with a value of +1 is a positive monopole, each pixel with a value of −1 is a negative monopole, and each pixel with a value of 0 is empty space. Therefore, the pixels of the image represent the density of charge and have values in the interval [−1, . . . ,1], where non integers are less intense charges. Different densities of charge will produce different electric potentials and fields, and larger densities of charge will contribute more to electric potentials and fields.

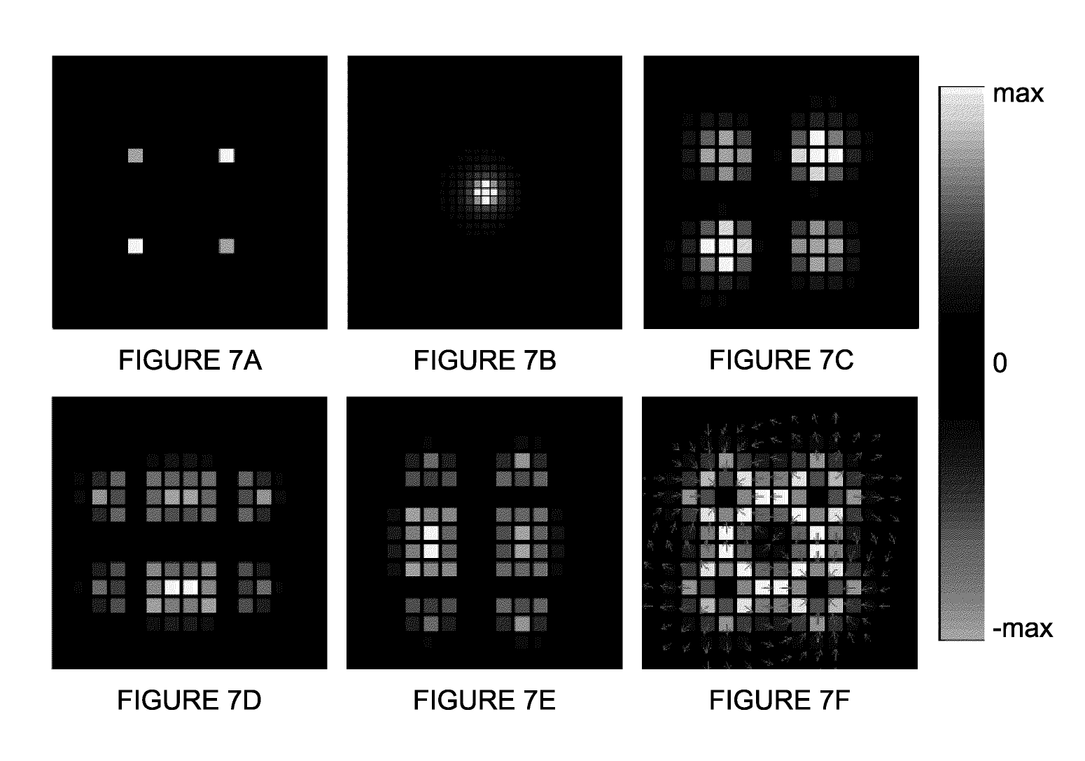

Next, the Pₑ matrix is constructed as seen in 5A and 5B, and applied on the image with the convolution shown at equation (12). Then, the horizontal and vertical derivatives are calculated using equation (10) and give the results for E^{x} and E^{y}. Finally, the norm and the direction of the field are calculated using equation (13). It is possible to visualize these steps at FIGS. 7A-7F.

Vₑ=I*Pₑ,size(Vₑ)=size(I)

E^{x,y}=Vₑ*δ^{x,y} (12)

|E|=\sqrt{(E^{x})²+(E^{y})²}

θ_{E}=a tan 2(E^{y}, E^{x}) (13)

The same process that is used to transform each pixel into a monopole can be used to transform them into a magnetic dipole, by using the result presented at FIGS. 6A-6C as the kernel. However, a density correction factor F must be added to take better account of the diagonal pixels. The equation for this factor is given at equation (14).

F=max(|cos(θ)|, |sin(θ)|)⁻¹⇒1≤F≤\sqrt{2} (14)

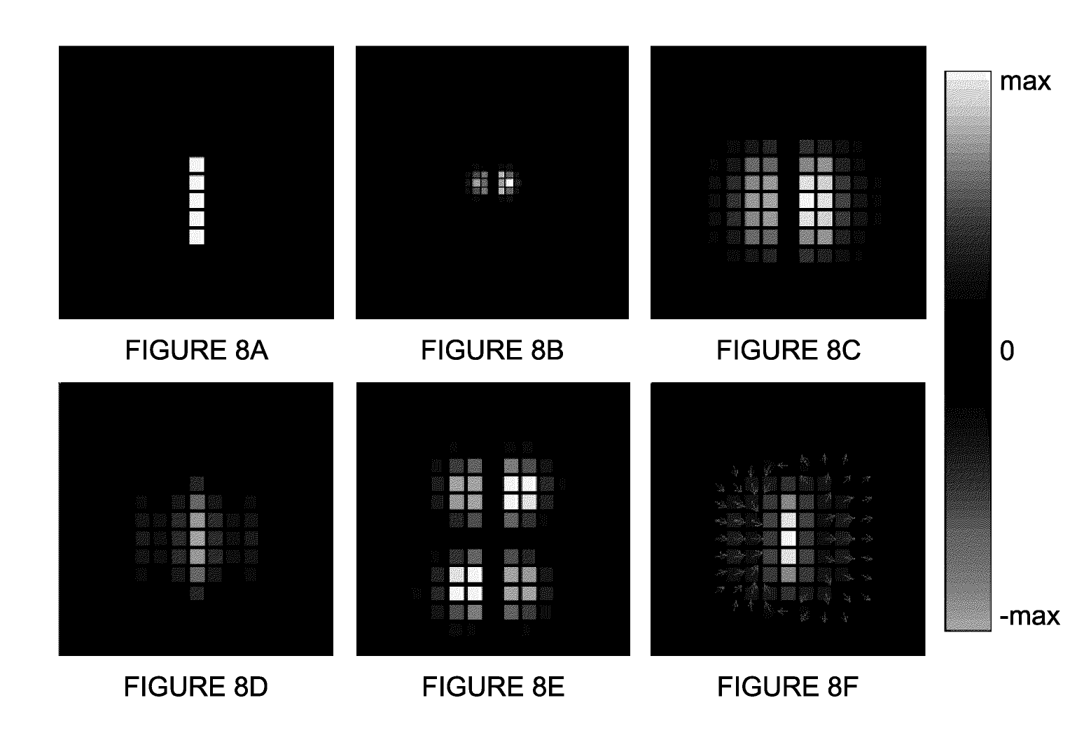

The steps and results are shown at FIGS. 8A-8F, when each pixel is transformed into a horizontal magnetic dipole with θ=0. The formula to calculate the magnetic potential using a convolution is given at equation (15). The angle θ is perpendicular to the gradient of the original image and is given at equation (16)(16). Also, the matrix size of Vₘ is the same as the matrix size of the image I.

Vₘ=(I·F·cos(θ))*P_{dip}^{x}+(I·F·sin(θ))*P_{dip}^{y} (15)

θ=atm²(I*δ^{y}, I*δ^{x})+270° (16)

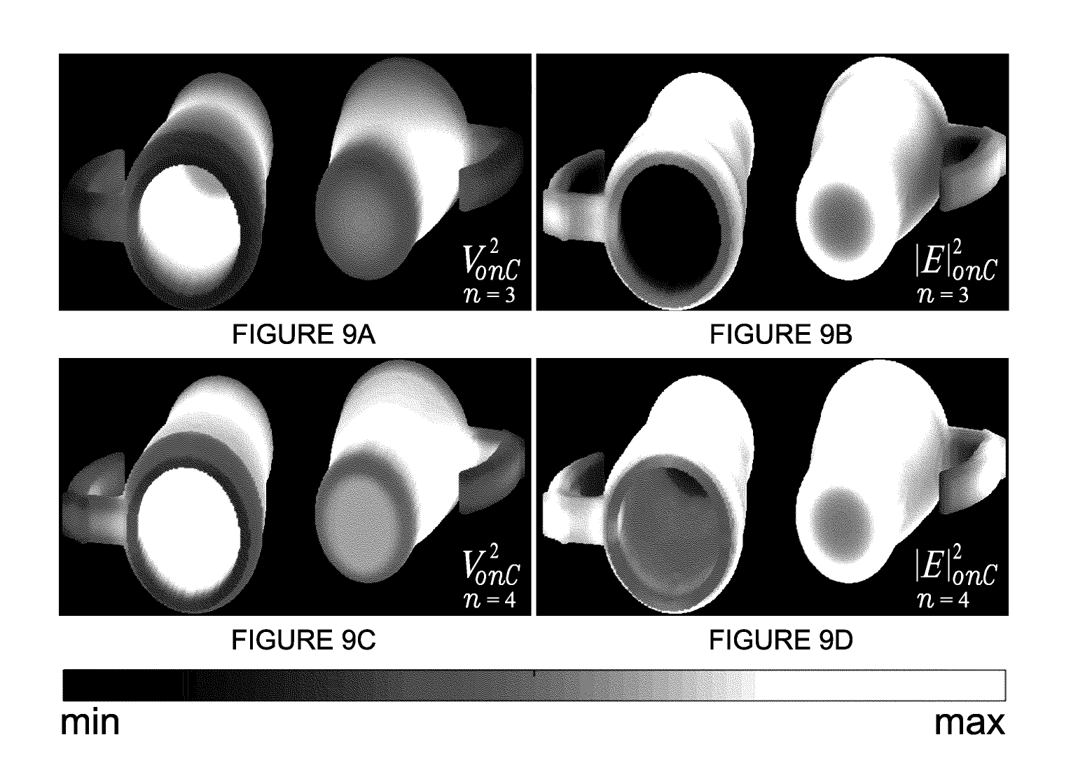

With reference to FIGS. 9A-D, it should be noted that similar techniques may be used to analyze properties of three-dimensional shapes. In some embodiments, the convolution kernel matrices used for Pₑ and Vₑ are three-dimensional matrices, and steps 104 and 106 of FIG. 1 are performed to calculate a three-dimensional electric potential and a three-dimensional electric field. Based on the three-dimensional electric potential and field, features such as concavity, convexity, and centre-of-mass of the object may be determined, as per step 108. In some embodiments, other features, for example whether certain points are enclosed by a shape, and whether certain faces of the object have another opposing face, are also determined. FIGS. 9A-B are analyses based on electric potentials and fields (respectively) with n=3, and FIGS. 9C-D are analyses based on electric potentials and fields (respectively) with n=4.

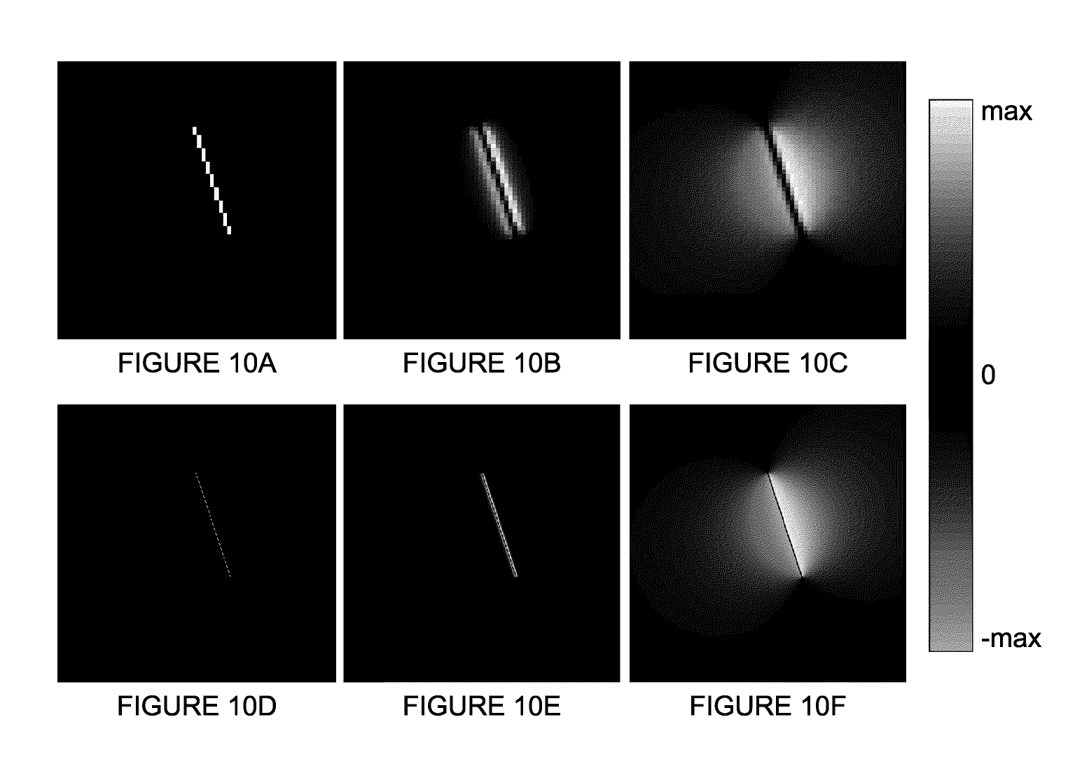

In reference to FIG. 10A-F, in some embodiments magnetic convolutions (i.e. which use a dipole) are used to analyze so-called “strokes” in images. A stroke is a line or curve having a value of ‘1’ in an image, having a background value of ‘0’, and which has a width of a single pixel. Put differently, a stroke is a line or curve of value ‘1’ pixels which each have at most two neighbouring pixels of value T. Example strokes are shown in FIGS. 10A and 10D.

When using magnetic convolutions, in order to make the magnetization scale- and resolution-invariant, a magnetic potential kernel with value n=2 is used. Examples of application of magnetic potential kernels to the strokes of FIGS. 10A and 10D are shown in FIGS. 10B-C and 10E-F, respectively.

In some embodiments, one of the features identified at step 108 of FIG. 1 is the contour of an object, and in some instances the contour of an object is identified on the basis of a partial contour which is completed with one or more additional contour portions. The partial contour is identified, for example, using gradient thresholding, which examines gradients in the electric field or potential, and establishes edges or contours for objects when the gradient exceeds a predetermined gradient threshold. To identify the features of additional contour portions, for instance the curvature of an additional contour portion, probabilistic methods described hereinbelow may be used.

A characteristic of the magnetic potential kernels with n=2 is that this value for n is the only value which ensures a conservation of energy in the potential and field of the image, since the image is in 2D. This means that Gauss's Theorem can be applied on the field produced by a stroke. By using Gauss's Theorem, we can know that any closed stroke, which is magnetized perpendicular to its direction, will produce a null field both inside and outside the stroke.

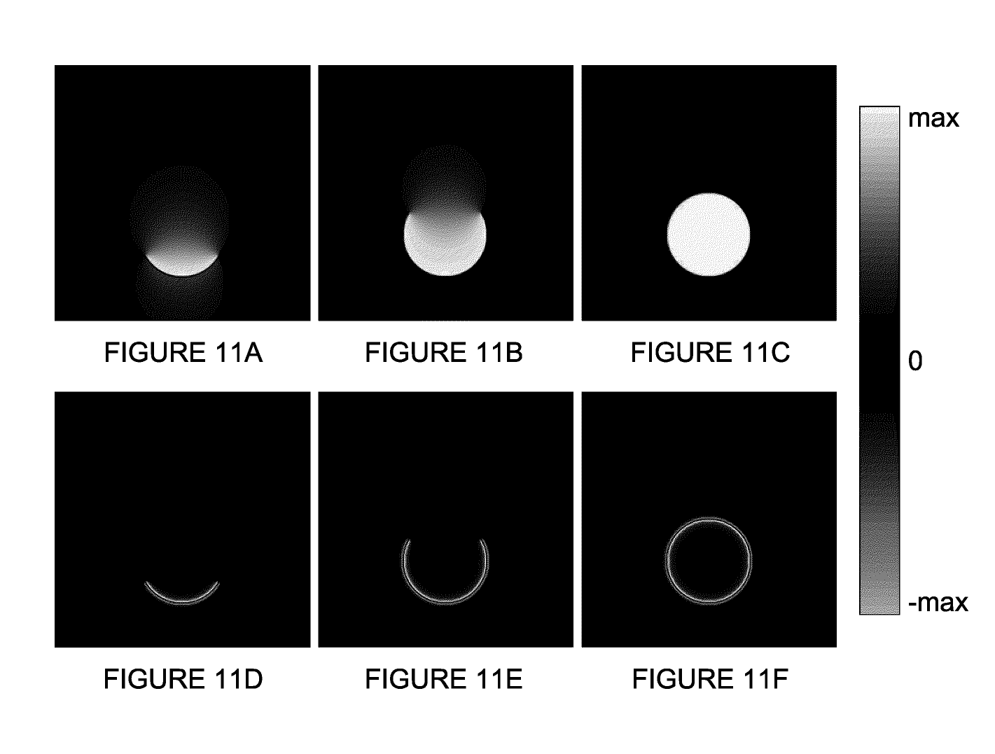

With reference to FIGS. 11A-F, with n=2, a stroke that is almost closed will have a higher potential |Vₘ| inside it, with a lower potential outside. This can also be applied to 2 or more strokes that interact with each other by magnetizing them perpendicularly to the strokes. It is possible to shift the value of θ by a factor of π on each stroke to flip the positive and negative side. By choosing carefully which stroke is flipped, it is possible to maximize the magnetic repulsion in an image.

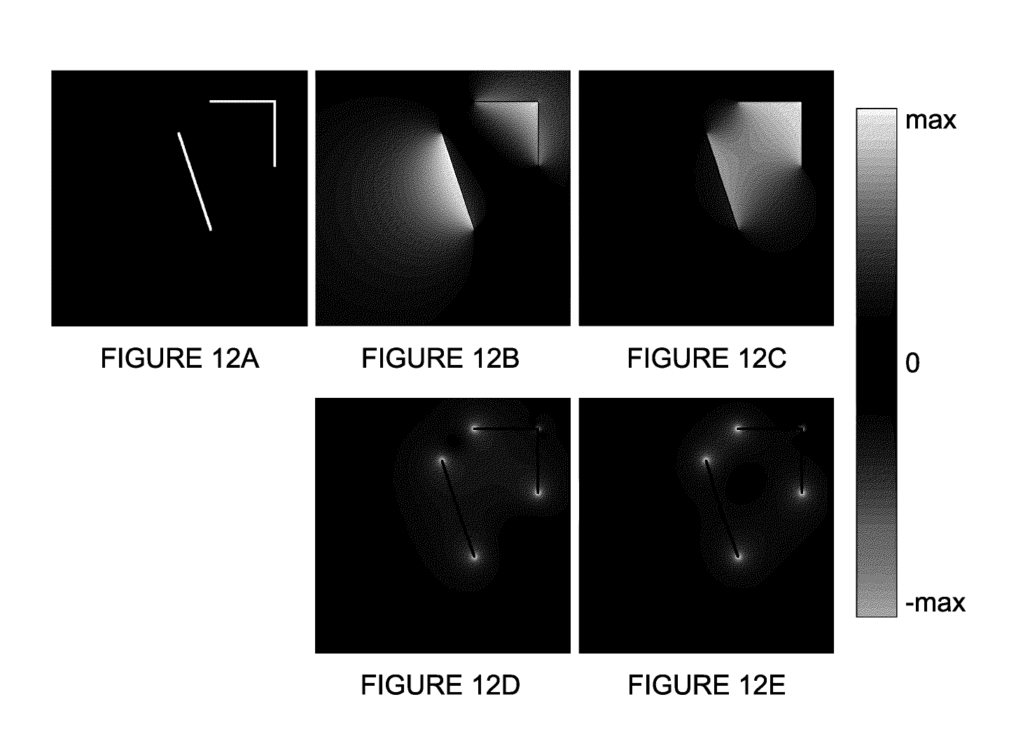

With reference to FIGS. 12A-E, magnetic interactions between the two polarized strokes are illustrated, with positive magnetic fields being illustrated in a darker gradient and negative magnetic fields being illustrated in a lighter gradient. In FIGS. 12B and 12 D, the two strokes are shown as being magnetically attracted, that is to say having the positive part of a first stroke interacting with the negative part of the other stroke. The magnetic potential produced by attraction interactions cannot be used to identify features in an image. However, when there is a repulsion (positive meets positive, or negative meets negative) as in FIG. 12C and 12E, there is a high concentration of magnetic potential |Vₘ| between the strokes, with an almost constant value (low magnetic field |Eₘ|). Henceforth, the magnetic repulsion interaction may be used to analyze the 2D space using only thin, essentially one-dimensional (1D) strokes in the initial image.

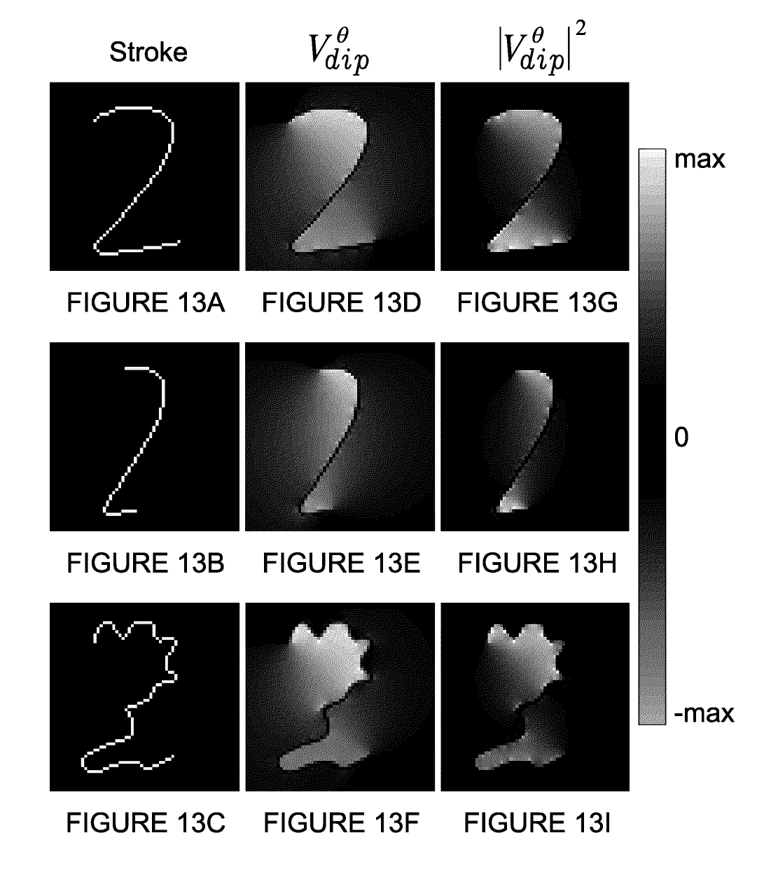

The use of magnetic potential kernels and fields allows for detection of the characteristics of a stroke which is robust to noise and deformation. Analysis of a stroke may be performed by considering the magnetic potential |Vₘ| produced by dipoles placed perpendicular to the stroke. Then, as seen in FIGS. 11A-F, a concave region will produce a higher value of |Vₘ|, while a convex region will produce a lower value of |Vₘ|. With reference to FIGS. 13A-I, an example of magnetic potentials is presented. Notably, the values of |Vₘ| are almost identical for the stroke (FIGS. 13A-C), the deformed stroke (FIGS. 13D-F), and the heavily distorted stroke. (FIGS. 13G-I).

Another mathematical characteristic relating to the use of magnetic potential kernels is the equipotential lines produced. If a straight, continuous stroke is magnetized perpendicular to its direction, then the equipotential lines will be circles that extend from one extremity of the stroke to the other extremity. Hence, any circles that pass between two points on the stroke are computed by a simple magnetization of the line between those points. If those two points are on the x axis, for instance at positions x_{1,2}=±x₀, then the equations of the potential is given by the equation (17) of a circle.

(y−cot(Vₘ)x₀)²+x²=x₀²csc²(Vₘ) (17)

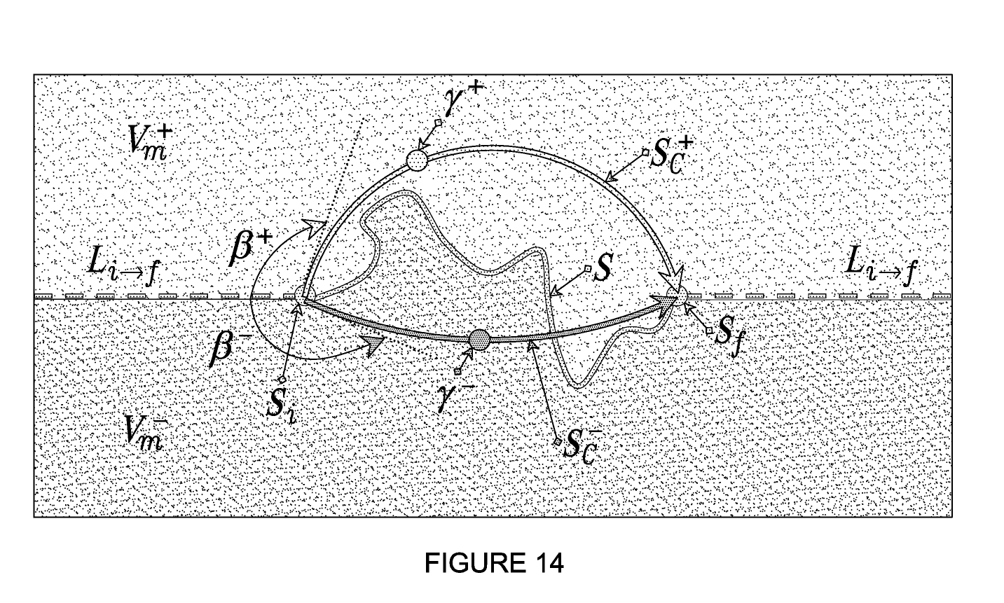

With reference to FIG. 14, for a non-self-intersecting stroke S that is magnetized perpendicular to its direction, the potential Vₘ will have a positive region Vₘ⁺ and a negative region Vₘ⁻. The values Vₘ of each equipotential line is linked to the angle β∈[0,2π] between the tangent of the equipotential circle and the direct line between each extremity of the stroke. The relation is given by the equation (18).

$${V}_{m} = \{ \begin{matrix}{V}_{m}^{+} = {β}^{+} \\ {V}_{m}^{-} = - {β}^{-}\end{matrix} \qquad ( 18 )$$

Hence, Vₘ will be equal to β⁺ on one side of the stroke and −β⁻ on the other side. It is to note that β⁺ and β⁻ can both be greater than π, if the point γ⁺ is below the line L_{i→f}, or the point γ⁻ is above the line L_{i→f}.

From this, it is possible to compute the probability P_{inC} that each point is contained in the contour C, where C is composed of the stroke S and at least one other stroke S_{C}, wherein S_{C} is not self-intersecting and has the same extremities Sᵢ, S_{f} as the stroke S. It is to note that C can be self-intersecting, although both S and S_{C} are not.

To compute P_{inC}, it is assumed that S_{C} is an arc of a circle, at which point the previously computed Vₘ can be used. Also, it is assumed that the choice of a circle for S_{C} is uniformly random over the angle β, if this circle has Sᵢ and S_{f} as extremities. Hence, P_{inC} is given by the number of shapes C formed by circles S_{C} which contain a certain point γ, divided by the total number of possible circles S_{C}. Since the distribution of S_{C} over β is uniform, then the probability is given by the equation (19).

$$\begin{matrix}{P}_{inC} = \frac{max ( β ( C ⊆ γ ) ) - min ( β ( C ⊆ γ ) )}{max ( β ) - min ( β )} \\ = \frac{1}{2 π} \cdot \{ \begin{matrix}{β}^{+} \\ {β}^{-}\end{matrix} \\ = \frac{\vert {V}_{m} \vert}{2 π}\end{matrix} \qquad ( 19 )$$

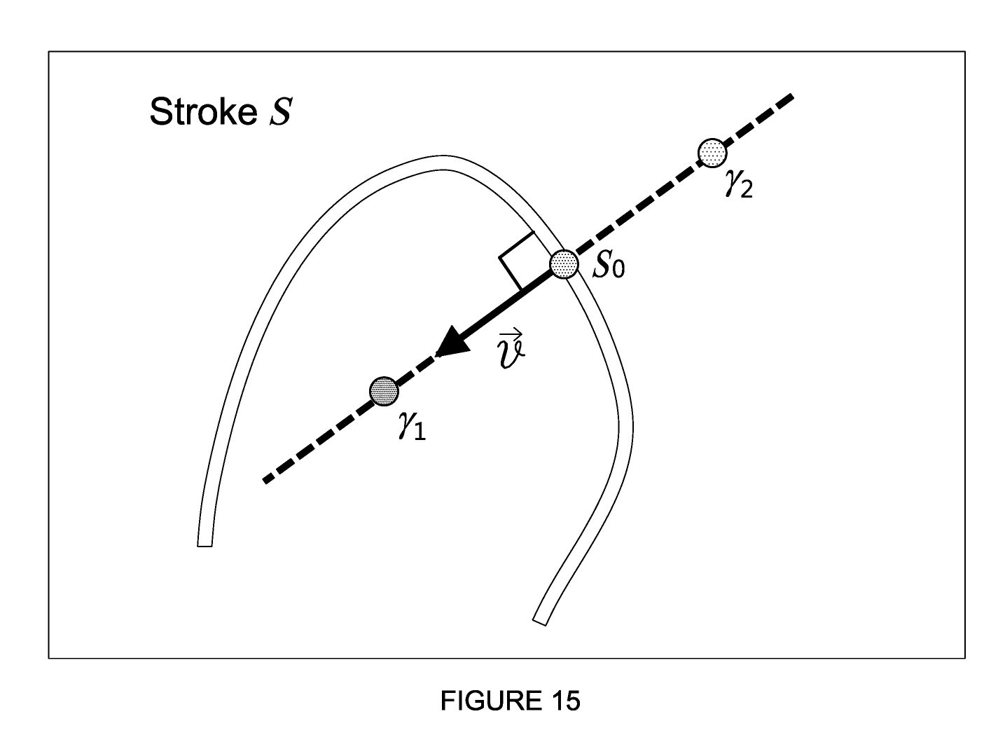

With reference to FIG. 15, two points γ_{1,2} at each side of a stroke S, positioned on a line perpendicular to S and passing through point S₀ are considered. The points γ_{1,2} can be expressed by the following equation (20).

γ_{1,2}=S₀+\vec{v}t_{1,2} (20)

Using equation 19 for P_{inC}, it can be shown that

$${lim}_{t \to 0} ( {P}_{inC} ( {γ}_{1} ) + {P}_{inC} ( {γ}_{2} ) ) = 1 \\ {γ}_{1} = {S}_{0} + \vec{v} t \\ {γ}_{2} = {S}_{0} - \vec{v} t \qquad ( 21 )$$

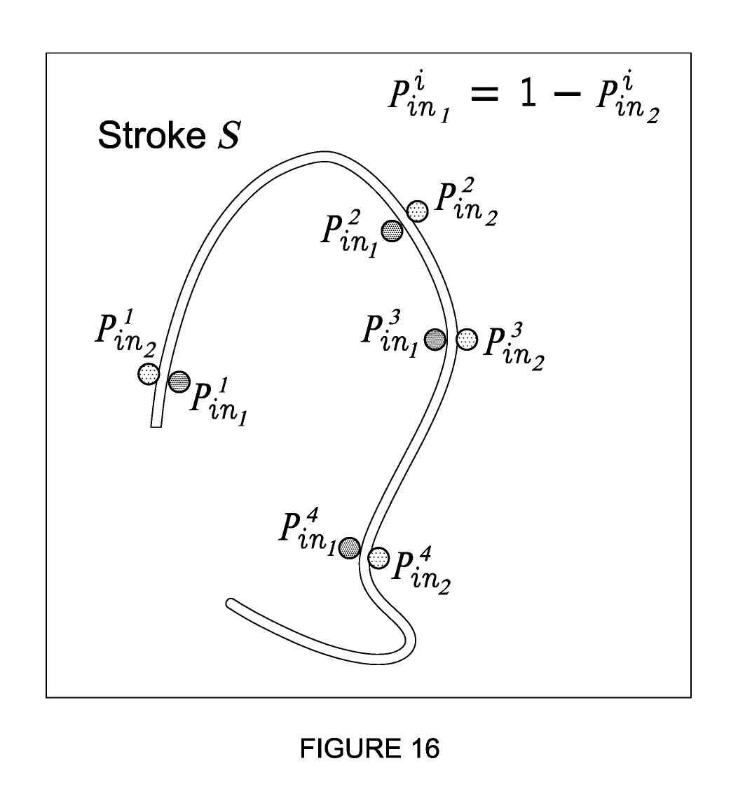

With reference to FIG. 16, complementary probabilities Pᵢₙ_{₁}=P_{inC}(γ₁) and P_{inC}=P_{inC}(γ₂) are illustrated. Computing the probabilities Pᵢₙ_{₁} and Pᵢₙ_{₂} is particular to computer vision, and comparing the probabilities Pᵢₙ_{₁} and Pᵢₙ_{₂} may be used to determine, at each point, what is the probability of being inside the incomplete stroke S_{C}. Additionally, various properties of the contour C, such as its length L, its area A, and its height Y may be determined using the following equations (22).

$$L = \frac{2 {x}_{0} ( π - \vert {V}_{m} \vert )}{sin \vert {V}_{m} \vert} \\ A = {( \frac{{x}_{0}}{sin \vert {V}_{m} \vert} )}^{2} \cdot ( \vert {V}_{m} \vert - cos \vert {V}_{m} \vert sin \vert {V}_{m} \vert ) \\ Y = cot ( \frac{\vert {V}_{m} \vert}{2} ) {x}_{0} \qquad ( 22 )$$

When multiple strokes are present in the same image, it is possible to use the stroke interaction that is shown previously, combined with the computation of probabilities. Hence, if the potentials Vₘ of each stroke i are aligned to maximize the magnetic repulsion, then the equation

$${P}_{inC} = \frac{\vert {V}_{m} \vert}{2 π}$$

still stands, where Vₘ=ΣᵢVₘ_{ᵢ}. In this sum, 0≤Vₘ≤1 still holds, and the probabilities remain complementary. Hence, it is possible to compute the probability of being inside a given shape composed of multiple open strokes.

Thus, comparing the probabilities Pᵢₙ_{₁} and Pᵢₙ_{₂}, or any collection of probabilities P_{inC}_{ᵢ}, it can be determined whether a particular point is more likely to be within a given contour, and thus to probabilistically determine a shape or curvature of portions of the contour. In some embodiments, the probabilistic techniques described hereinabove are used to identify features of an image using the magnetic potential and field, including a contour for various objects in an image.

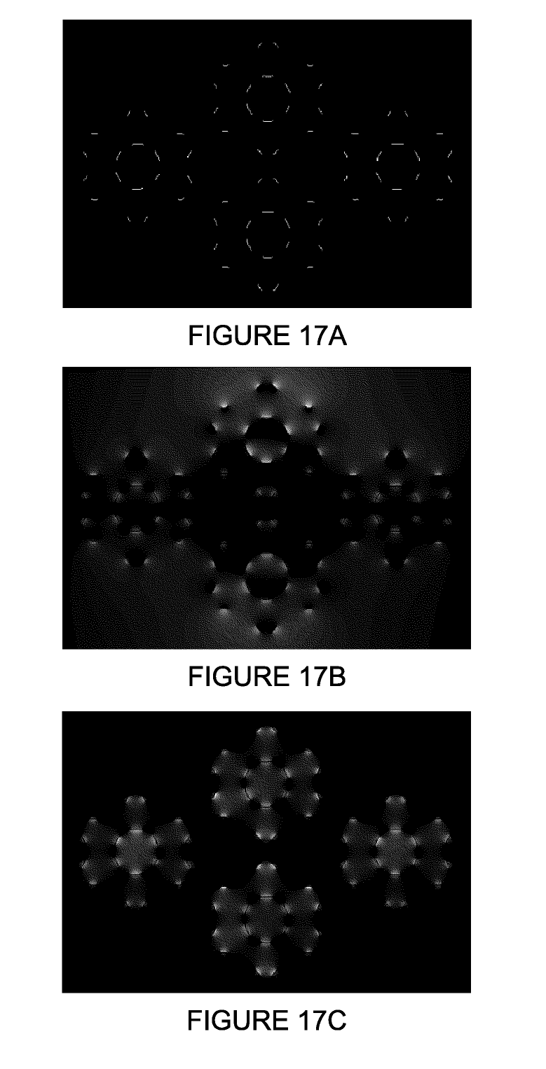

With reference to FIGS. 17A-C, identifying the partial contour may be performed via gradient thresholding, as shown in FIG. 17A. One issue with thresholding an image gradient is that a high threshold will produce incomplete contours, while a low threshold will have many undesirable features. In some embodiments, a high gradient threshold is used to identify the partial contour, and the probabilistic techniques based on magnetic potential kernels are used to identify the additional contour portions.

In FIG. 17B, initial potentials Vₘ for a variety of partial strokes are calculated. Then, the orientation of each stroke is flipped in an optimization process to maximize the total repulsion, as in FIG. 17C. The repulsion maximization may be used to locate objects within the image and to simplify the identification of features, including contours, of a complex image made of partial contours.

Once the repulsion process is completed, the resulting P_{inC}, L, A, and Y can be computed for many different shapes inside the image. From the resulting values, it can be determined whether contours removed by thresholding should be kept. For instance, the probabilities P_{inC} for a variety of possible additional contour portions can be compared to determine an orientation or a curvature for an additional contour portion to be added to the partial contour. In some embodiments, an iterative process that adds a part of the removed contour at each iteration can be implemented, until each contour is fully closed. The computed probabilities P_{inC} can also be used to determine which additional contour portion has a higher priority of closing, or otherwise completing, a partial contour. The completed contour can then be used for image segmentation.

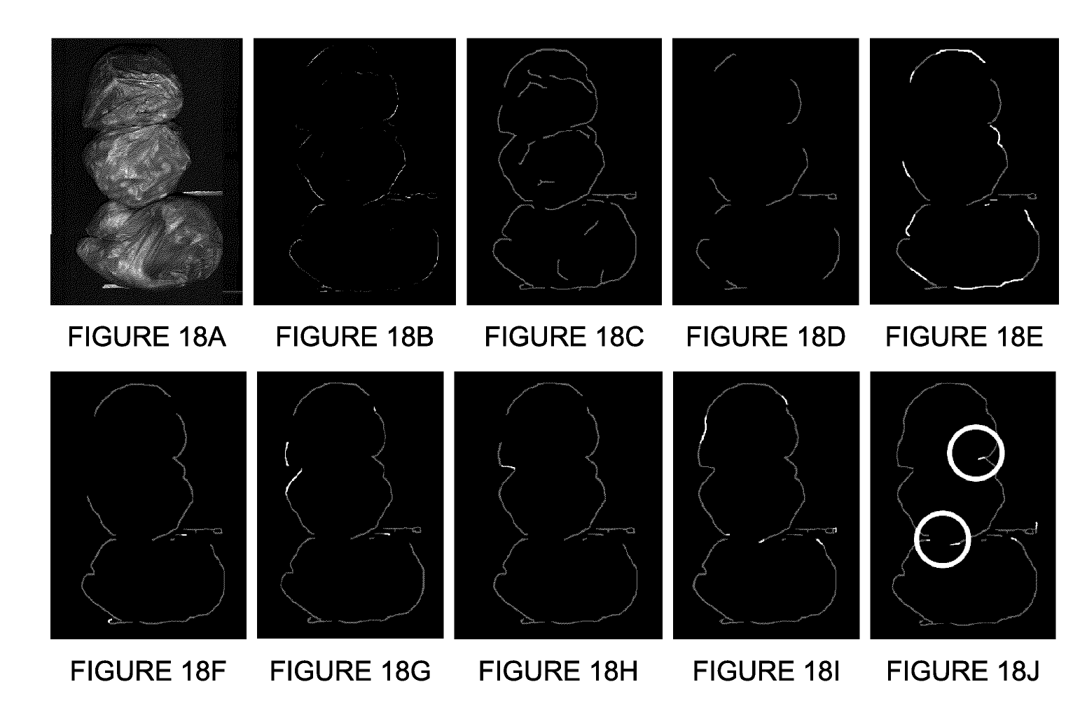

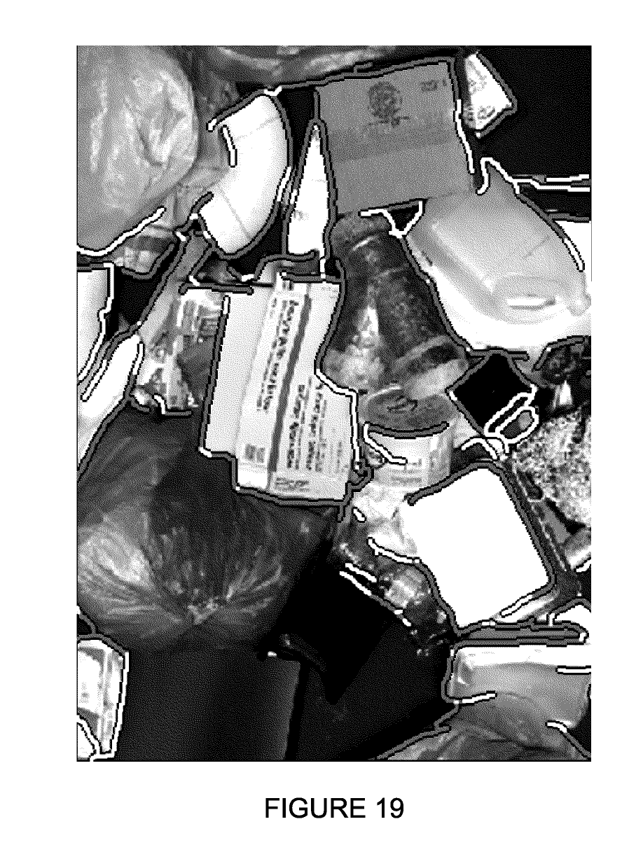

With reference to FIG. 18A-J, results of an iterative repulsion process for completing a partial contour with additional contour portions is shown. FIG. 18A shows the original image, and FIG. 18B shows a gradient of the image. FIGS. 18C-D show low- and high-threshold applications of gradient thresholding, and FIGS. 18E-J show how additional iterations of the repulsion process are used to complete the partial contour from the high-threshold gradient with additional contour portions. Additionally, FIG. 19 shows an example application to a complex image after eight iterations. In some embodiments, the magnetic interactions between strokes are used to understand relations between the various partial contours of objects in an image.

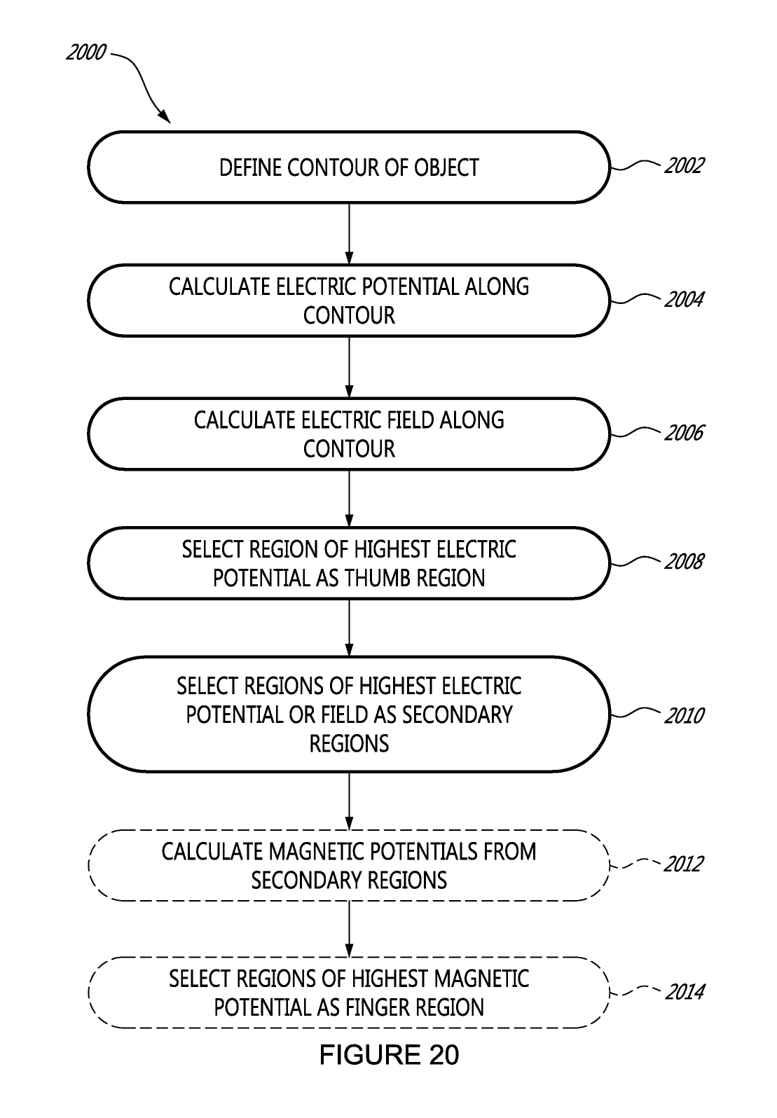

In some embodiments, the above notions are applied to shape analysis, specifically how to determine the optimal grasping regions and how to detect the presence of handles. FIG. 20 illustrates an example method 2000 for determining at least two grasping points for an object from an image.

At step 2002, at least one contour of an object is an image is defined. In some embodiments, the contour is defined as a combination of a partial contour and one or more additional contour portions, which may be determined probabilistically.

An object can usually only be held from the contour of the object as seen in an image. Therefore, the potential and field analysis is applied to the contour by ignoring the potential and fields inside the shape. The pixels inside the shape are considered as charged particles when calculating the potential and fields. It is to be noted that some objects are better held from the inside, like a bowl or an ice cube tray, and these objects will be discussed in further detail below.

Once the contour of the object is detected and defined, contour regions may be manipulated by “growing” them or by “shortening” them. A contour region is defined as a group of pixels that are part of the contour. The growing or the shortening keeps the region as part of the contour. The growing may be used as a security factor that ensures the most significant part of a given region is not missed. It is also suitable to unite nearby pixels into a unique region. The shortening may be used to prevent two adjacent regions from intersecting when they should not. When shortening a region, at least one pixel is maintained in the region.

To make sure that the growth is consistent no matter the size of the shape, the percentage of biggest length (% BL) is defined as the rounded number of pixels that correspond to a certain percentage of the total number of pixels on the biggest length of the image. For example, if the image is 170×300 pixels, a value of 6% BL is 18 pixels.

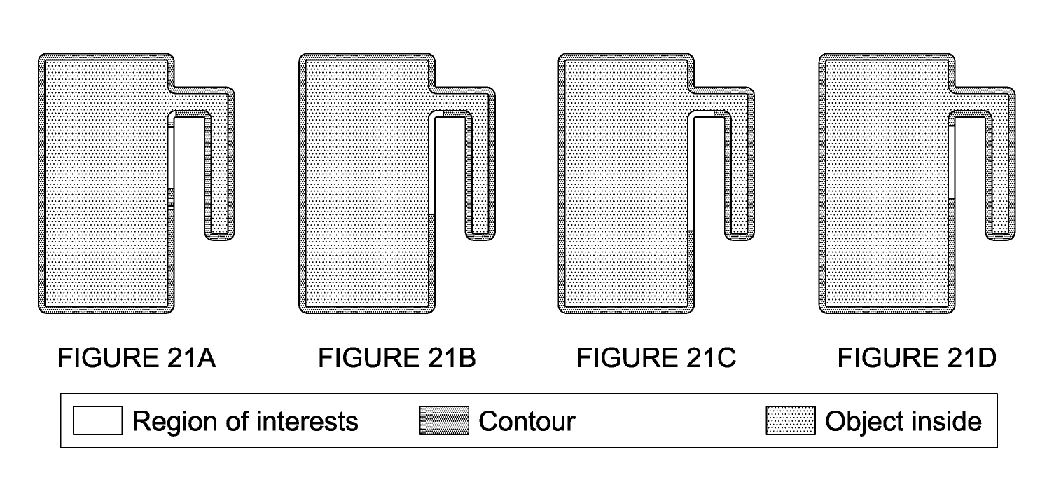

When a region of interest is found, the first step is to create a united region (UR) using a growth value. In some embodiments, the growth value used is 1.5% BL. This avoids having nearby pixels that are not together due to a numerical error. Then, the UR may be grown or shortened by a certain value of % BL. An example is illustrated in FIGS. 21A-D, where a region of interest is united, then grown or shortened by 6% BL. Other growth values may also be used.

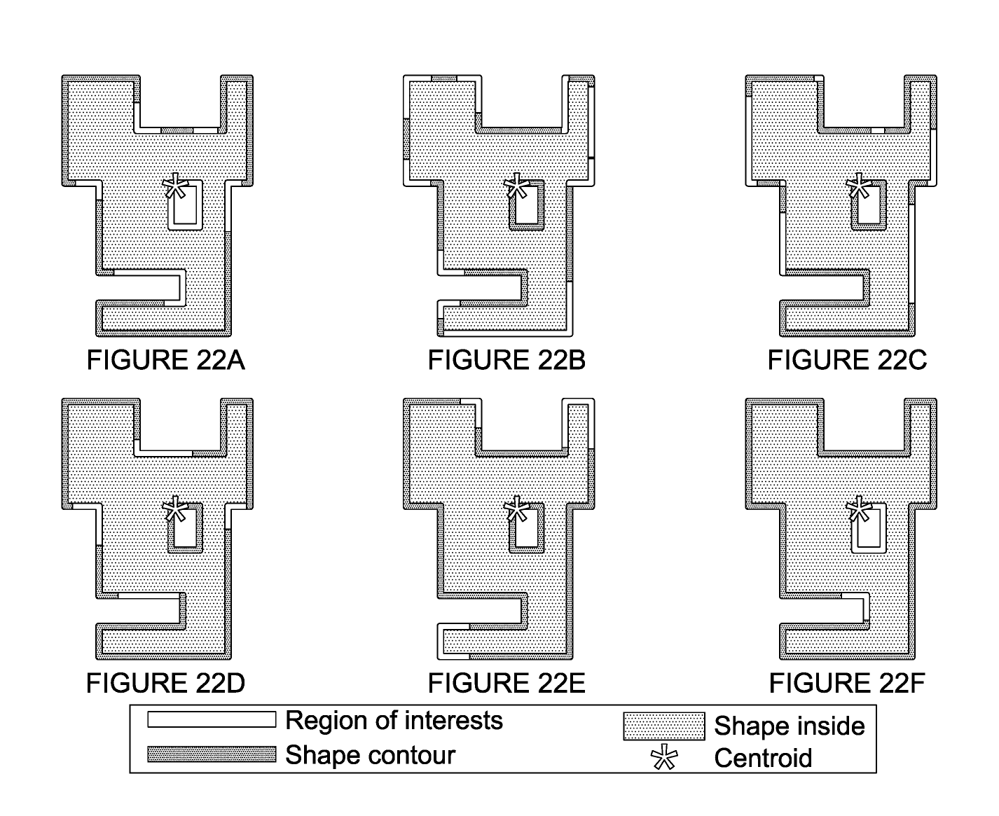

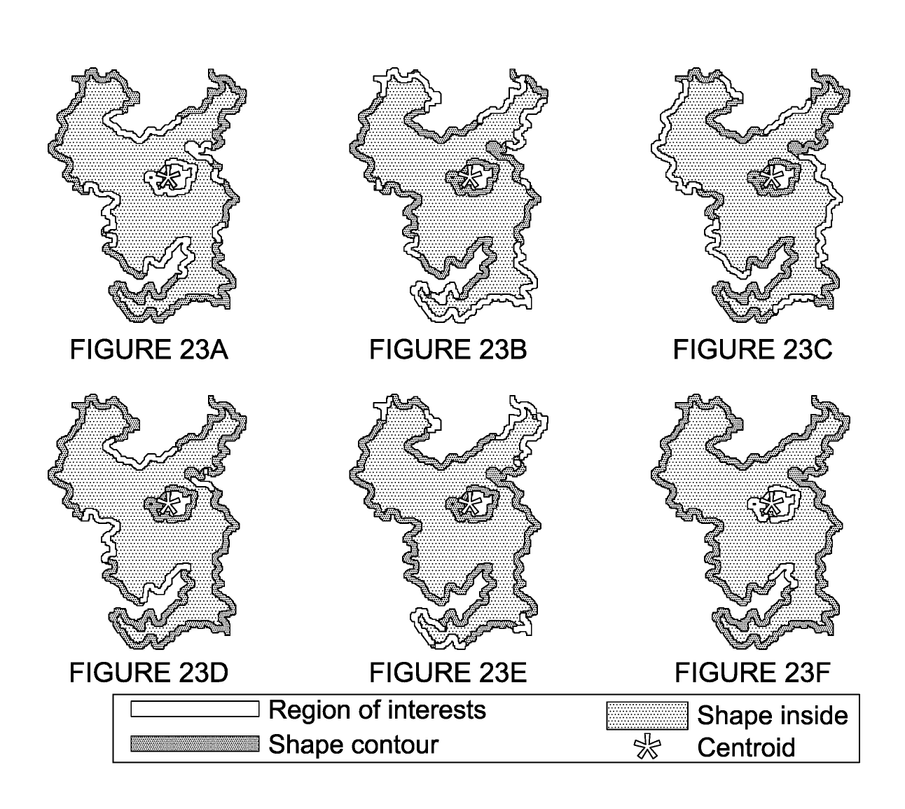

Different regions of interest can be found, depending on the concavity or convexity of each region, and their proximity to the centroid of the given shape. An example of the computed regions is illustrated for a complex shape in FIGS. 22A-F. Another example is illustrated in FIGS. 23A-F, which show that the technique is resistant to heavy distortions in the original shape.

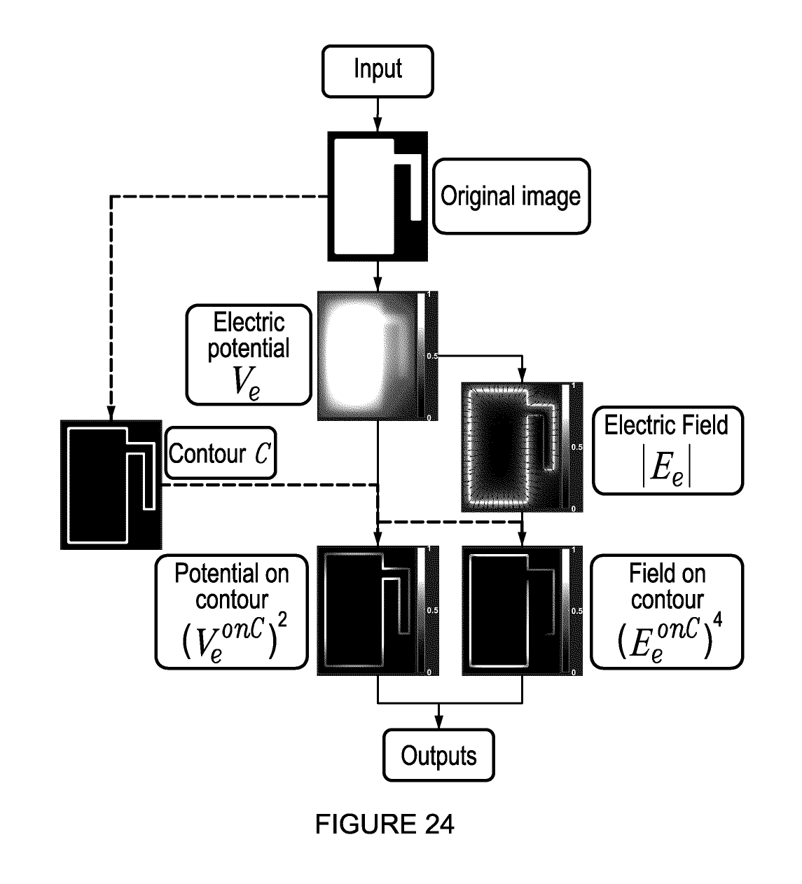

To determine a grasping region, 2D images of objects are used as input, with pixels of value 1 inside the shape and value 0 outside the shape. The steps to get the potential and field on the contour are summarized in FIG. 24 with a mug, where the contour has a thickness of 1 pixel but is exaggerated for a better visualization.

Once the contour is determined, the next steps are to calculate the potential and the field that is generated by the image if we consider each pixel with a value of 1 as an electric charge, as per steps 2004 and 2006. The potential Vₑ is calculated by using the convolution (12) and the field |E| is calculated with the convolution (13). The particle potential kernel Pₑ is calculated as described by FIGS. 5A and 5B, and is given by the same equation as Vₑ for a single particle in equation (7). The variable n is chosen in 3D for this example, so n=3. In some embodiments, the n parameter can be optimized using a database. A value of n<3 means that more importance is attributed to the centroid of an object. A value of n>3 means that more importance is attributed to the local convexity/concavity of the object. The potential and field are only considered on the image contour, and their values are the products given at equation (23).

Vₑ^{onC=V·C}

Eₑ^{onC}=|Eₑ|·C (23)

The regions of interests are regions that are used to find the exact position of the fingers inside them. To determine the regions of interests for grasping, Vₑ^{onC} and Eₑ^{onC} are used. These regions are defined as a group of connected pixels on the contour of the image, and they are found by using threshold values that are based on TABLE II. It should be noted that the potential and the field are both normalized so that their maximum value is 1, and that some thresholds are in percentile. Example threshold values are presented in TABLE III.

TABLE III

| Regions | VTh | Op | PTh (%) |
|---|---|---|---|
| Thumb | Vₑ^{onC} > 0.98 | AND | Vₑ^{onC} > 98 |
| Secondary fingers | — | — | Vₑ^{onC} > 91 |
| Other fingers | — | — | (Vₑ^{onC} > 60 AND Eₑ^{onC} > |
| | | | 70) OR |
| | | | (Eₑ^{onC} > 90) |
| Handle and Thin | Eₑ^{onC} < 0.5 | AND | (Vₑ^{onC} < 90 AND Eₑ^{onC} < |
| | | | 30) |

The first region to find is the region where to position the thumb, as per step 2008, which corresponds to the region having the highest electric potential. The thumb should be placed at the most stable location of the object, which is the concave region near the CM. Example thresholds for thumb regions are illustrated in Table III. In the case of a circle, every pixel has an almost equal potential and the whole contour may be considered as a possible region for the placement of the thumb. In this case, a single pixel is selected randomly. After that, all the UR will be removed except the one with the highest amount of pixels. If there are multiple UR of the same size, it means that there is symmetry and it is possible to select one randomly. The thumb region will then be modified once the secondary finger region is found.

Secondary finger regions are regions for placing the second grasping finger. As step 2010, the regions of highest electric potential or electric field are selected as secondary regions. In some embodiments, they are concave and near the CM, although they may also be flat or farther away from the CM. According to the characteristics of Table II, example thresholds for secondary finger regions are presented in Table III. In this example, these regions are united (1.5% BL growth) without any further growth.

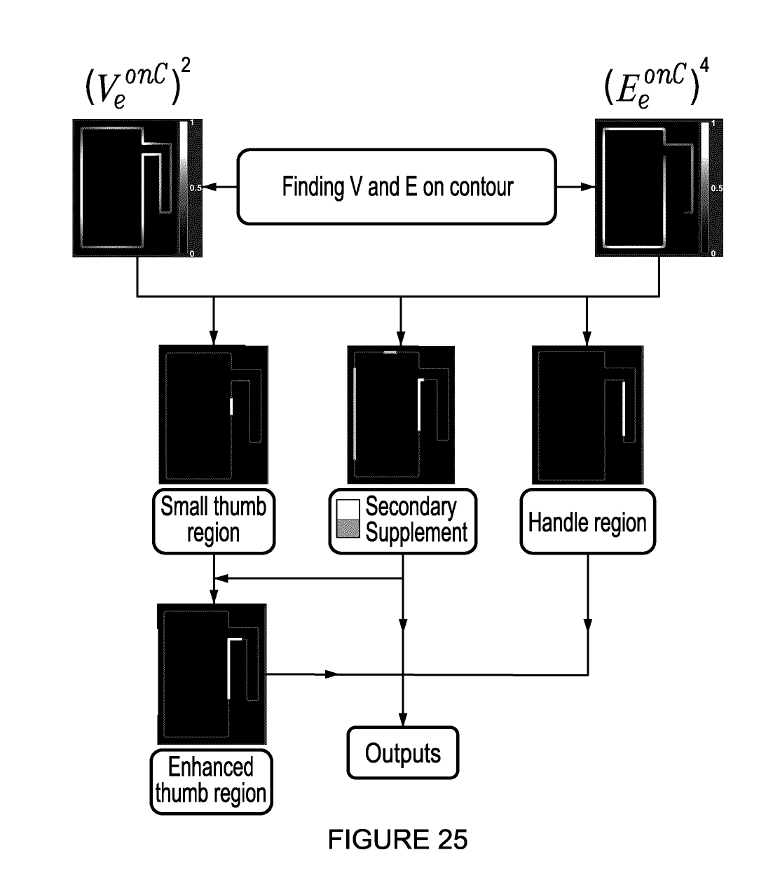

In some embodiments, the method 2000 comprises finding the “secondary finger region” that contains the “thumb region”. The thumb region is then replaced by the corresponding secondary finger region, because it is bigger. In some embodiments, the UR is extended, for example with a 6% BL growth, to add a security factor. This process is illustrated at FIG. 25.

If there are not enough detected regions, other possible regions, i.e. supplementary finger regions, may be found, although they may not be optimal. These regions may be less concave, flat or slightly convex. They may also be a little further away from the CM. Example thresholds for the supplementary finger regions are presented in Table III, but cannot be applied directly because the AND operator will not work well if the regions of Vₑ^{onC}>60 AND Eₑ^{onC}>70 are near intersecting.

Regions for Vₑ^{onC}>60 and for Eₑ^{onC}>70 are first found, and then each one is united (for example, 1.5% BL growth) before being grown (for example by another 2.5% BL). After this growth, the AND operator is applied. Finally, a region is found for Eₑ^{onC}>90, the region is united, and the OR operator is applied. This region excludes previously found pixels that are in the thumb region or the secondary finger region. The logical operators maximize the chance of selecting the most interesting regions.

In some embodiments, handles or thin regions of an object may also be detected. These regions serve as grasping alternatives in case the object is too big, too hot, too slippery, etc. To detect the inside of the handle, it is first confirmed that it is inside the shape (but not necessarily closed) and that it is far from the CM. As shown in Table II, the inside of the handle occurs where the field is extremely low and the potential is medium to high. These characteristics for the potential and field occur also for another scenario where the shape is really thin near the CM but thicker elsewhere, like a badminton racquet or a wine glass. The difference between the two types of regions will be explained in further detail below.

The thresholds for the handles and thin regions are given in Table III, but in some embodiments the AND operator cannot be applied directly. The regions for Vₑ^{onC}<90 and Eₑ^{onC}<30 may be both independently united (for example with a growth of 1.5% BL), then the UR are shortened (for example by 2.5% BL). After these transformations, the region for Eₑ^{onC}<0.5 is united, then all AND operators are applied.

In some embodiments, if a handle is smaller than 7% BL, it is dismissed because handles are usually bigger. This condition may be used to reduce the chance of a false positive.

Table II presents additional information about the shapes of the objects. For example, the pointy or thin corners are where both Vₑ^{onC} and Eₑ^{onC} are low. Also, if there is a hole in the object, then it is like a handle but nearer to the CM, which means that the Vₑ^{onC} will be extremely high and the Eₑ^{onC} will be extremely low.

An example is presented at FIG. 25 to illustrate how to find the regions of interests for the same mug presented in FIG. 24. In some embodiments, only regions of interest for fingers are determined. Alternatively, optimal points from the regions are determined for every finger. This may be done by making use of the magnetic dipole potential, as per step 2012.

Taking, for example, a region of interest such as the thumb region, the point at the opposite side of the object is found for placing the second finger. However, the second finger should be in a secondary or supplemental region. It should also be a stable grasp point, meaning that the line joining the second finger to the thumb should be almost perpendicular to the contour. The second finger should also be near the thumb to allow a smaller and simpler grasp, and apply a force in an opposite direction as the thumb to avoid slipping. Finally, we would like to find multiple points that respect all those characteristics to allow an optimal multi-finger grasping.

One way to directly meet all of the above cited constraints is to use magnetic potential. By magnetizing a region using dipoles perpendicular to the contour, it is possible to find multiple points that are highly attracted to this magnet (the highest Vₘ), by considering only those on the regions of interest of the contour. In some embodiments, a value of n=1.7 is used to find Pₘ from equation (7), but other values may also be used. By ignoring the negative potential, it is possible to choose the desired direction of the other fingers by changing the direction of the magnet. The magnetic potential is given by equation (15) and the value on the contour by equation (24).

Vₘ^{onC}=Vₘ·C (24)

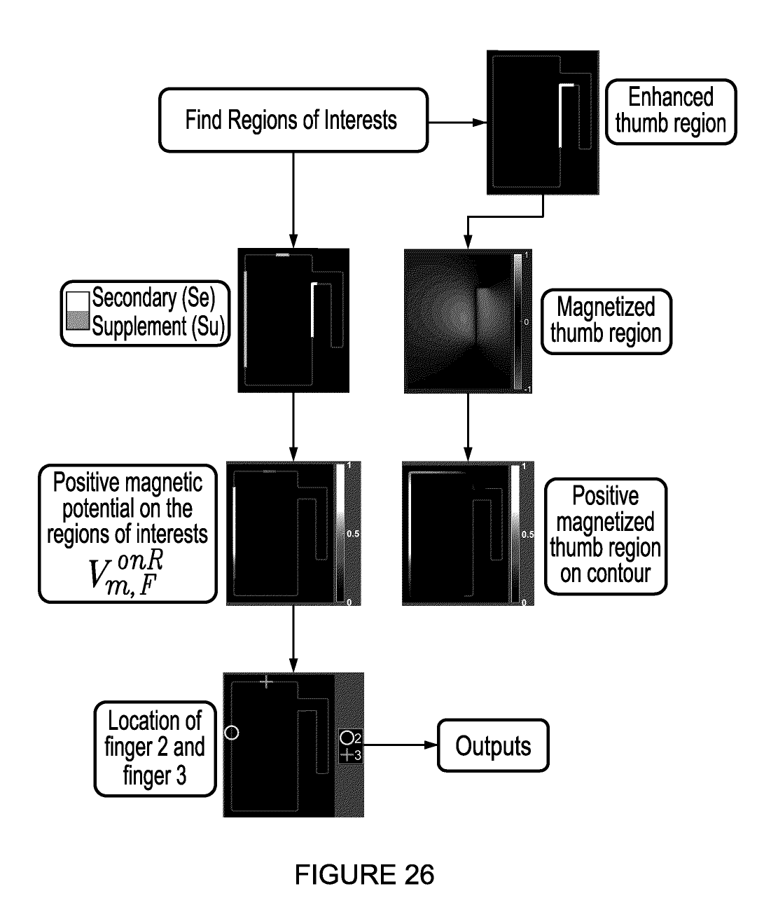

Magnetization allows one to find the grasping region for any number of fingers desired. An example for finding fingers opposite to the thumb using magnetization is shown in FIG. 26. As a robot rarely exceeds 5 fingers, the present disclosure only describes one thumb and four opposite fingers, like the human hand. However, hands having more or less than five fingers may also be used. The thumb and finger #2 are the primary fingers, while other fingers, such as fingers #3, 4 or 5, are secondary. Finger #2 is not necessarily the index finger, it could be any finger, but there has to be a finger at this location to ensure stability of the grasp. In some embodiments, only three locations are found for the fingers. In this case, the best locations for fingers #4 and #5 may be alongside fingers #2 and #3. The regions of highest magnetic potential as selected as finger regions, as per step 2014.

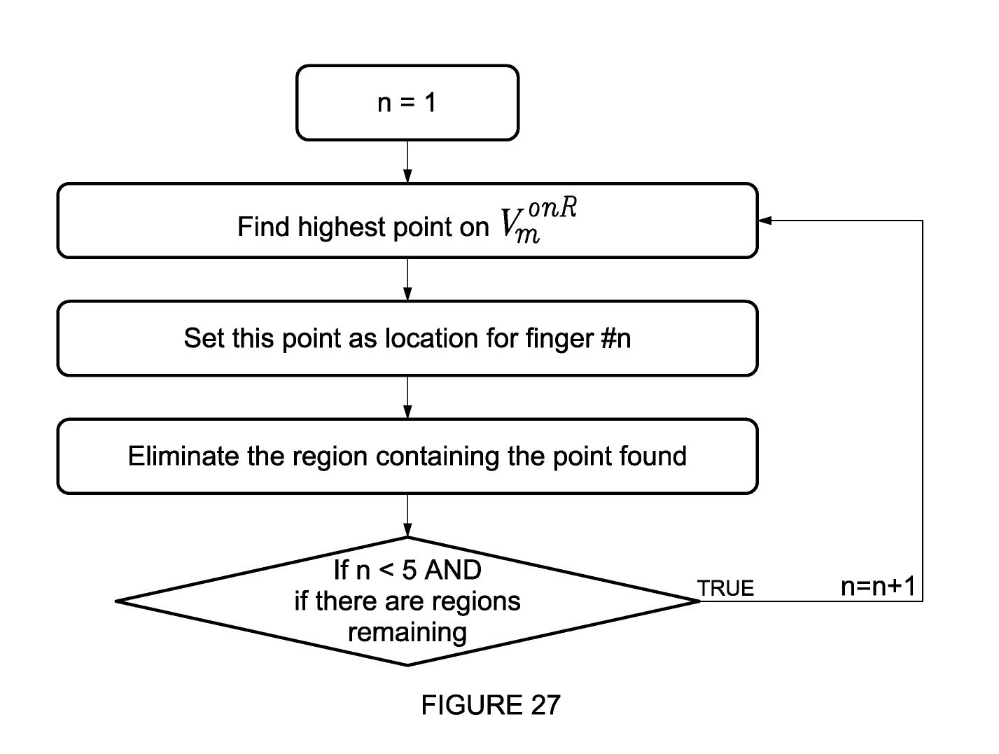

To find the regions for each finger, the value of V_{m,F}^{onR} given by equation (25) is determined by using the secondary regions (Se), the supplementary regions (Su), and the potential generated by the magnetization of the thumb region (V_{m,TR}^{onC}). An example algorithm to find the exact position is presented at FIG. 27. Once equation (25) is calculated, the thumb region is grown of 8% BL, and V_{m,F}^{onR} is set to zero on this new region. This allows to make sure that the highest potential is not present on the pixels directly near the thumb region.

V_{m,F}^{onR}=positive(V_{m,TR}^{onC})·(Se+0.9·Su) (25)

The exact position of all fingers is now known, except for the thumb which is still a large region. The exact location of finger #2 is taken and the UR is grown, for example with a growth of 6% BL. Then, finding the thumb location is similar to what was presented in FIG. 26, with the magnetization V_{m,F2}^{onC} done on the grown region of finger #2. For the thumb, the value of V_{m,TR}^{onR} is given by equation (26), where TR is the thumb region. Finally, the thumb location is the point with the highest potential. If there are multiple points with the maximum value, then a single location may be randomly selected.

V_{m,TR}^{onR}=positive(V_{m,F2}^{onC})·(TR) (26)

Once the interior of the handle is found, it can be used to find the opposite side of the handle. The method to find the internal handle is already illustrated in FIG. 25 but according to Table III, it could also correspond to a thin region on the middle of the shape, like on a badminton racquet. Note that there could be multiple handle regions in a single shape, and the process must be repeated for all of them. The following process applies only to a single handle.

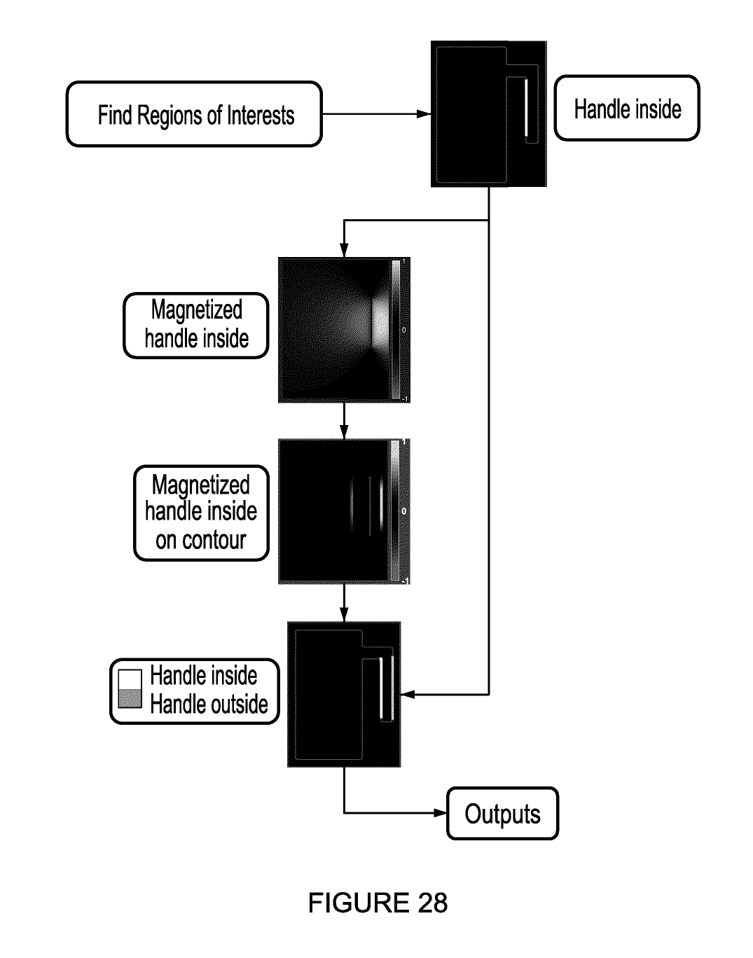

To determine if it is a handle or a thin region, it is first determined where the opposite side of the handle is. To do so, one of the handle regions is magnetized and the potential is calculated on all of the contour V_{m,hand}^{onC}. Then, a percentile threshold, for example of V>91%, is applied and the pixels are united (for example using a growth of 1.5% BL), which leads to multiple possible regions. Based on the opposite side being from a similar shape as the internal handle, all regions except the one with the most pixels respecting the threshold may be ignored. Finally, the region is grown or shortened until the size of the opposite handle is around the same size as the internal handle. An example of this process is presented in FIG. 28.

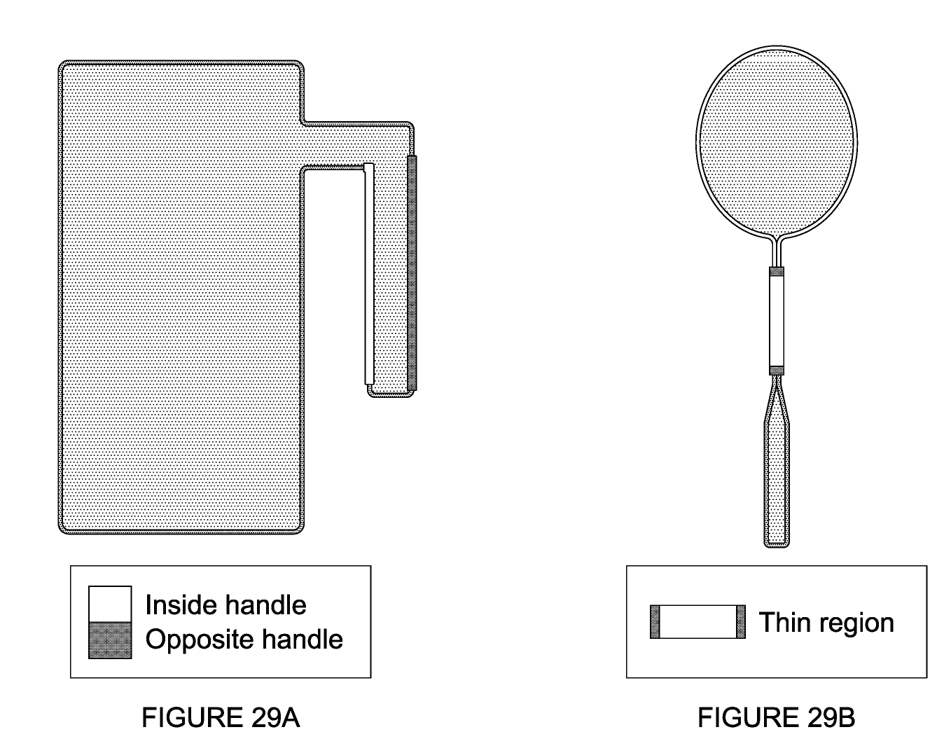

If it is a thin region, then the majority of the pixels from the opposite handle will be coincident to another inside handle. Otherwise, it is a normal handle. A comparison of the thin region from a badminton racquet and a cup handle is presented at FIG. 29A and 29B.

In some embodiments, it may be desired that the grasping happens in a certain direction. The method may be adapted by adding a preferential direction. The angle θ_{pref} is defined as the orientation of the vector that goes from finger #2 to the thumb. Then, the preferential potential is defined as a matrix the same size as the image, containing only values between 0 and 1 and is given by equation (27). In this equation, P_{ref}^{x} is a linear function that is 0 at the left and 1 at the right, while P_{pref}^{y} is a linear function that is 0 at the bottom and 1 at the top.

$${P}_{temp} = {P}_{pref}^{x} cos ( {θ}_{pref} ) + {P}_{pref}^{y} sin ( {θ}_{pref} ) \\ {P}_{pref} = \frac{{P}_{temp} - min ( {P}_{temp} )}{max ( {P}_{temp} )} \qquad ( 27 )$$

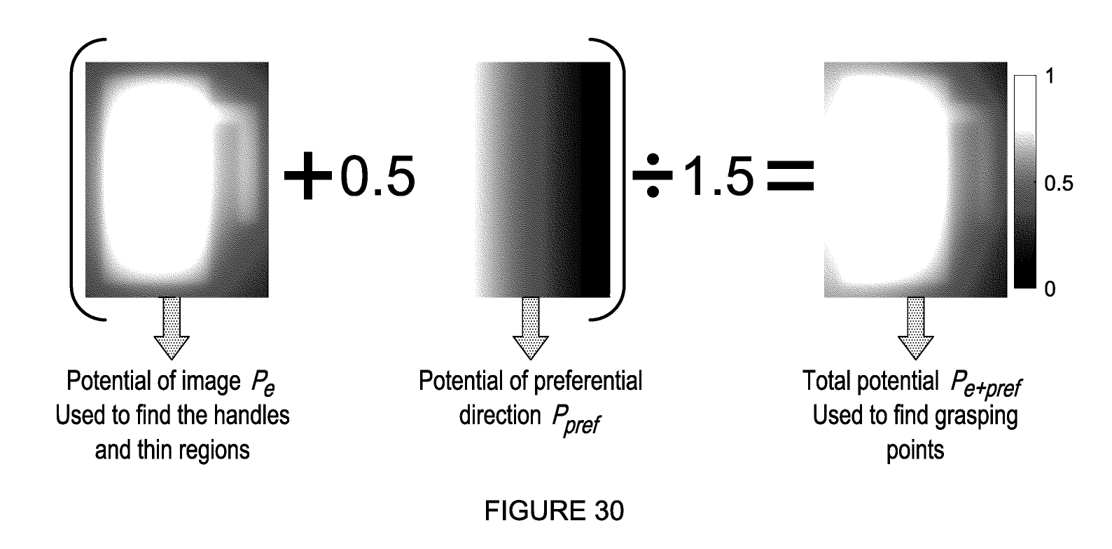

Then, equation (28) may be used to obtain the new total potential P_{e+pref} where a is a weight factor for the preferential direction. An example for α=0.5 and θ_{pref}=180° is given at FIG. 30, where it can be seen that the potential is substantially higher at the left of the mug.

$$\frac{{P}_{e} + α {P}_{pref}}{1 + α} = {P}_{e + pref} \qquad ( 28 )$$

It should be noted that α should not be too big, or the grasping points will simply favor any direction without considering the shape of the object. Therefore, in some embodiments α<1 may be used.

The methods disclosed herein are applicable to many different shapes. A total of 70 shapes or objects were used to test the method, with 20 objects possessing a handle and 7 objects possessing a thin region. A grasp is considered stable if a finger can be placed at the required points and produce a force that is almost perpendicular to the contour, and that all the forces can cancel themselves. Furthermore, a grasp is more stable if the force vectors intersect near the CM.

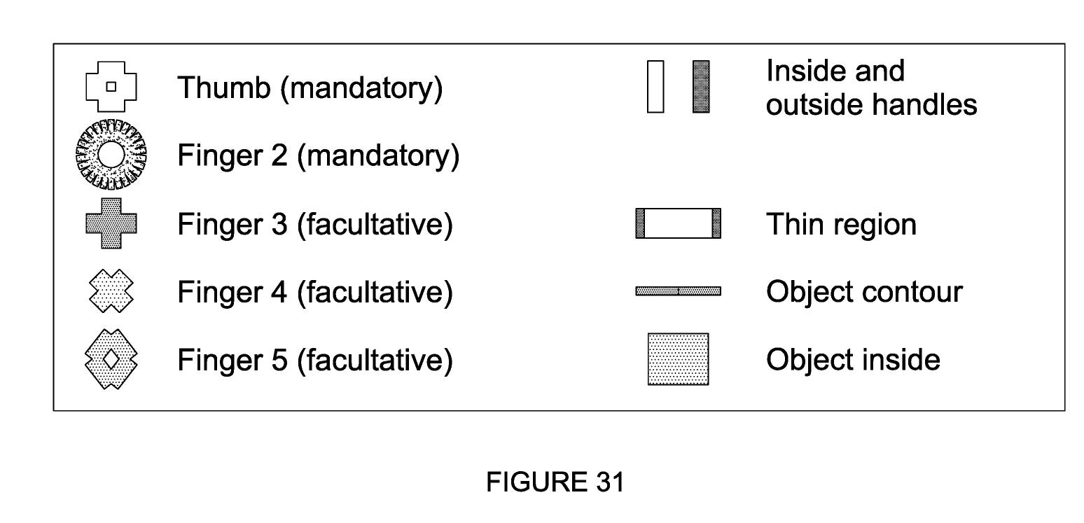

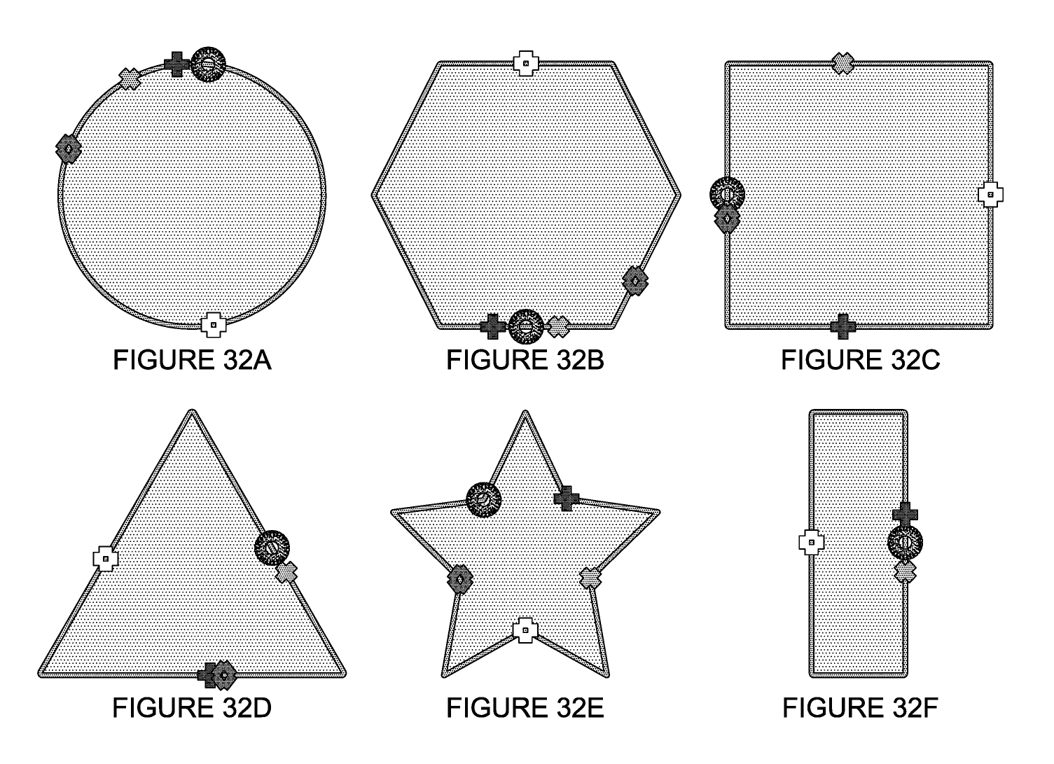

For FIGS. 32 to 39, the legend used is the one presented at FIG. 31. This legend shows the thumb and fingers #2, #3, #4, and #5. On some images, there are missing fingers, which means that any other finger may be placed adjacent to an already presented finger. For example, if fingers #4 and #5 are missing, then they may be placed alongside fingers #2 and/or #3.

Furthermore, the detected handles are shown with two parallel lines, the white line being the inside of the handle and the orange line being the outside of the handle. Finally, a single white line, with small orange regions at its border, represents the thin regions.

The first tests were done using six simple shapes that are often used for objects, and the results are shown at FIGS. 32A-F. We can observe that the two finger grasp (including only the thumb and finger #2) is always completely stable. The only exception is the equilateral triangle, which is really hard to grasp using 2 fingers. However, a three finger grasp for the equilateral triangle works well by putting a finger at the middle of each side. From all the studied simple or complex shapes, the most complicated to grasp were the circle and the equilateral triangle, due to their high symmetry and their low number of sides.

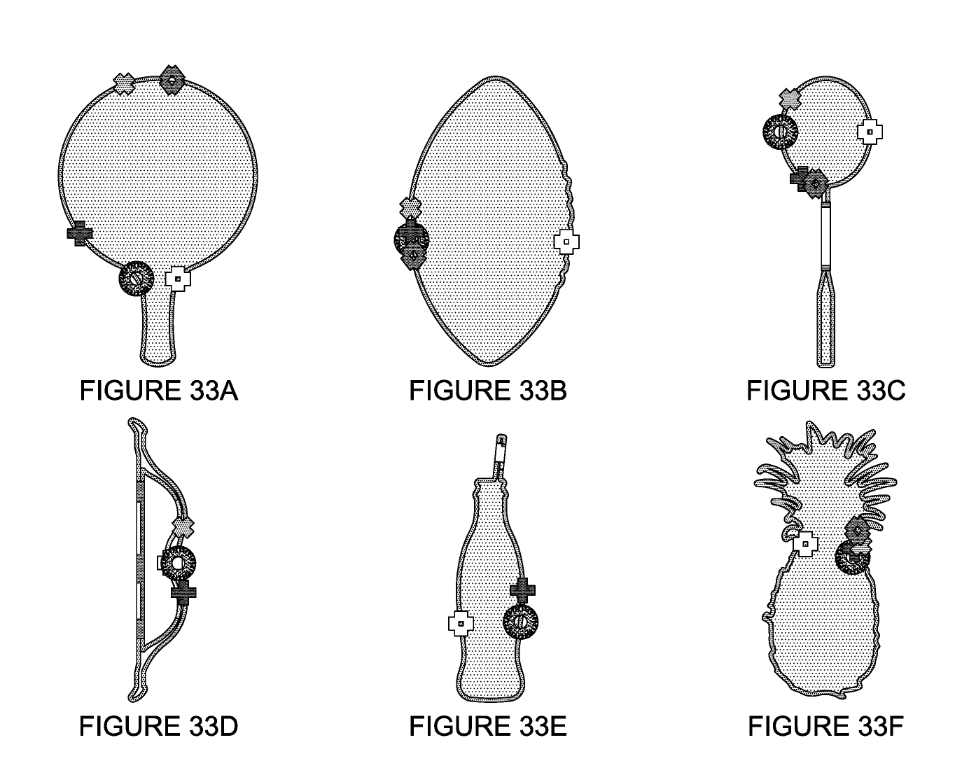

The same technique may be applied to more complex shapes, as seen on FIGS. 33A-33F, where it is shown that the two-fingers grasp yields stable results and that adding fingers improves the results. Even with objects of high complexity, like a grid, the grasping points are ideal by being near the CM and by putting some distance between the thumb and the finger #2. The method was also able to detect the presence of handles at various locations around the grid. Finally, the method was successfully tested on a Koch fractal, which is an object of infinite complexity, with the grasping points present in the bottom of different concave area.

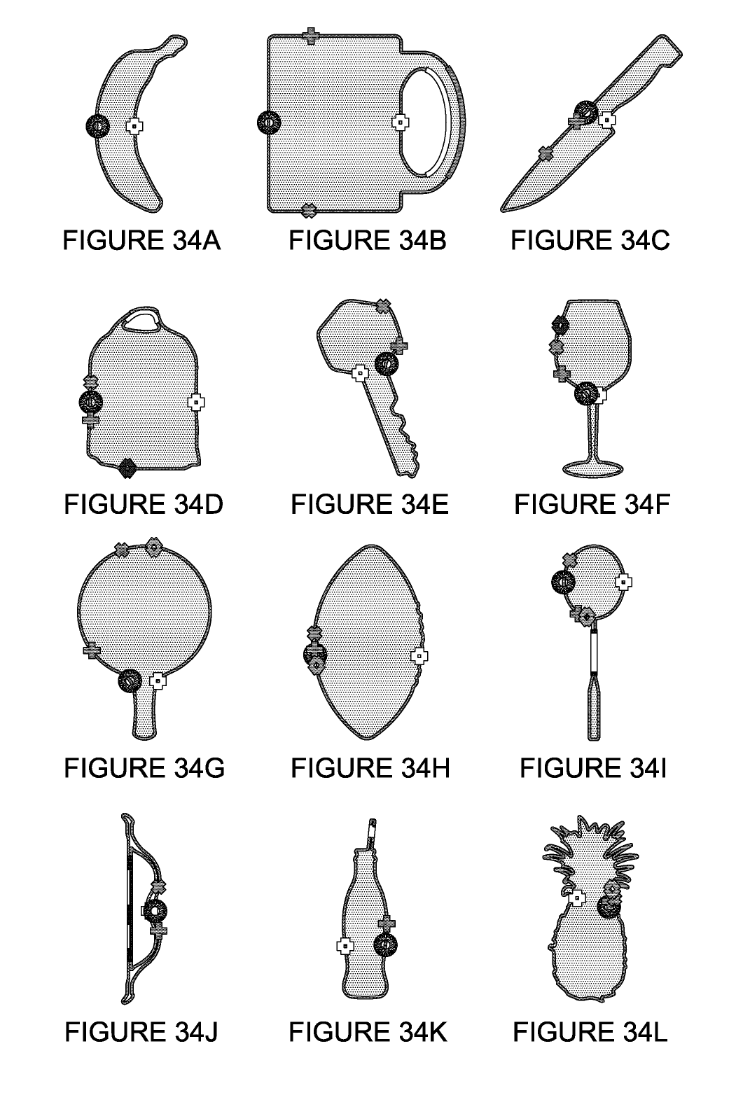

Objects present in everyday lives are presented at FIGS. 34A-L, where it is shown that the two-points grasping is stable and that the multi finger grasping provides additional stability. For the banana in FIG. 34A, all the support fingers may be alongside finger #2. In FIG. 34C, the grasping points of the knife favor the handle and avoid the cutting area.

For the bag in FIG. 34D and the mug in FIG. 34B, the handle is detected correctly. A bag is usually too big to be held from the sides and needs to be held from the handle. The thin part is detected on both the arc in FIG. 34J and the badminton racquet in FIG. 34I. The method may also be effective for highly complex objects like pineapples, as shown in FIG. 34L.

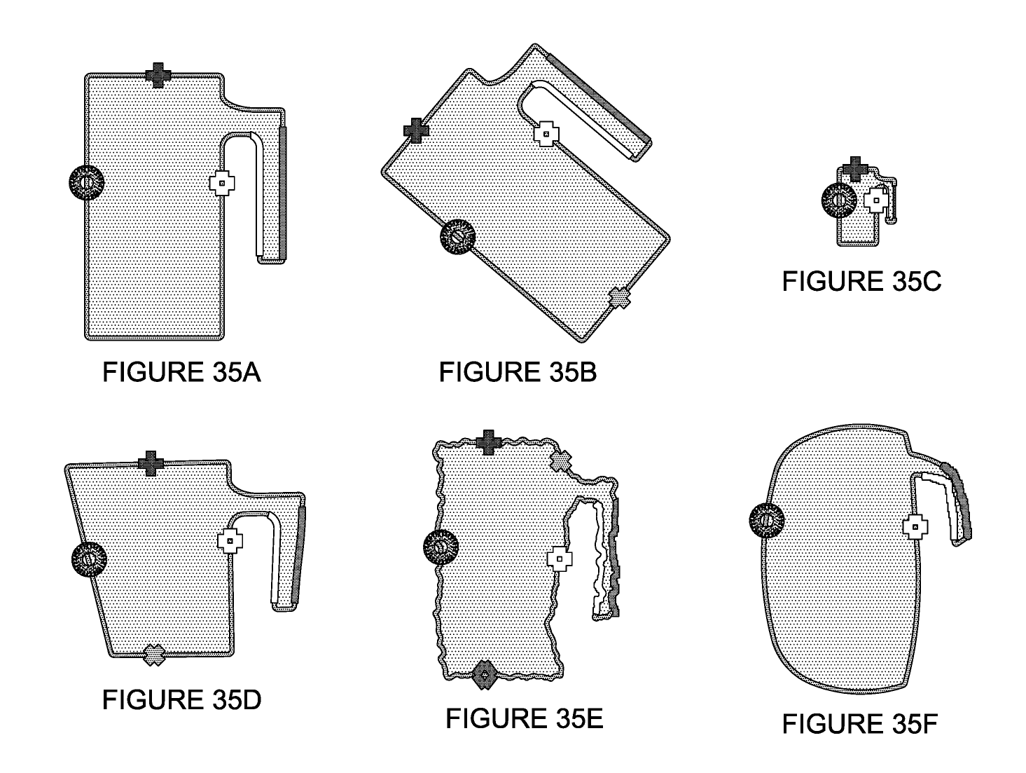

With reference to FIGS. 35A-F, it is demonstrated that, in accordance with certain embodiments, the method 2000 is highly versatile and robust because it still produces substantially the same results no matter the size, the orientation and the distortion of the object. All the images of FIGS. 35A-F represent the same object that has been manipulated with extreme distortion, far greater than what is present with cameras. For the rotation, the result is normal because the kernel Pₑ is symmetrical in rotation. We also see that the handle is always detected, that the thumb and finger #2 are always at the same place, and that finger #3 is only missing on one of the images because of a high distortion on the nearby corner. This great robustness is due to the fact that the algorithm does not rely on local pixels to determine the grasping points, but on all the pixels in the image. Therefore, no matter the strength of the distortion on a local area, the general shape will not change much and the results will be substantially identical.

In an example implementation, the success rate for a two-finger grasp was 98.6%. The success rate for an effector of three fingers or more was 100%. From the twenty tested objects that possess a handle, the detection resulted in a 100% success rate (with one false positive). For the detection of thin regions, 5 out of 7 regions were detected (71%), with one false positive.

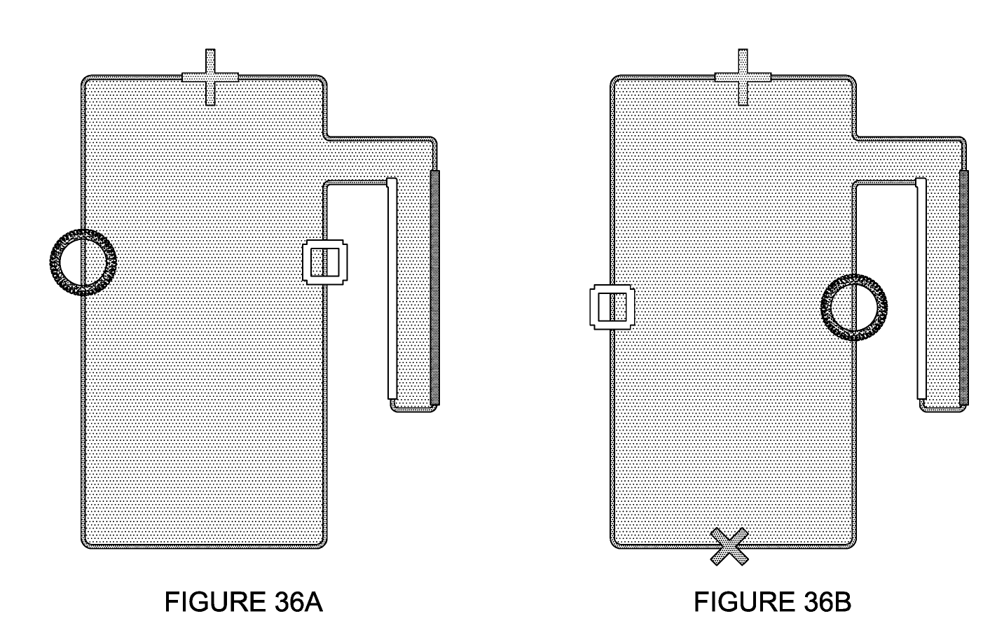

FIGS. 36A and 36B illustrate how the preferential direction of equations (27) and (28) affects the grasping points of a mug when the parameters are α=0.5 and θ_{pref}=180°, which favors a thumb at the left of the mug. It can be seen that the preferential direction has caused the position of the thumb and finger #2 to be switched. Also, the two positions are slightly lower and a new position has appeared for finger #4. For the handle, it remains unchanged because Pₑ and Eₑ are still used to find its location, without the preferential potential.

Due to the 3D shapes of real objects, some of them have an optimal grasp that is inside the shape, for example a shoe or an ice cube tray. In some embodiments, it is possible to find the external and the internal contours of an object using segmentation techniques such as Canny, or by using a depth sensor to avoid detection of false contours. By doing this, the optimal grasping regions inside the object may be found.

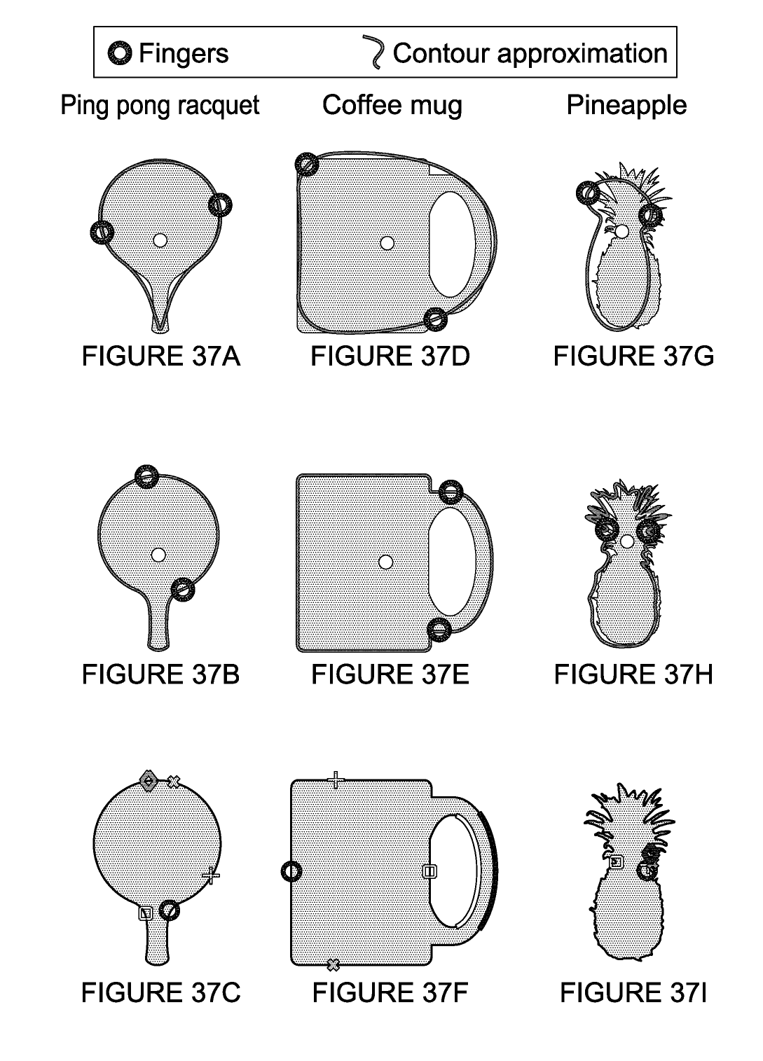

FIGS. 37A-I present a comparison of the present method (FIGS. 37G-I) with a curvature maximization method when the Elliptic Fourier Descriptors (EFD) are used with 4 harmonics (FIGS. 37A-C) and a curvature maximization method when the EFD are used with 32 harmonics (FIGS. 37D-F).

When using the curvature maximization method, the results are poor when used with complex objects, even when the number of harmonics is high, such as 32. In contrast, an example implementation of the present method, yields stable results on the three presented objects, at least in part due to the fact that the curvature maximization method ignores the CM, ignores holes in the objects, and cannot provide a satisfying approximation unless the number of harmonics is really high. Also, it is very dependent on the force closure, which will favor a grasping perpendicular to the shape. When the shape is approximated, some regions are in a different orientation than they should be. Therefore, the example implementation of the present method yields more stable results with two fingers, as it holds the Ping-Pong racquet from the handle, as in FIG. 37G, the cup from its sides, as in FIG. 37H, and the pineapple from the root of the leaves, as in FIG. 26I. Also, the supplementary fingers may add more stability to the grasping when they are feasible.

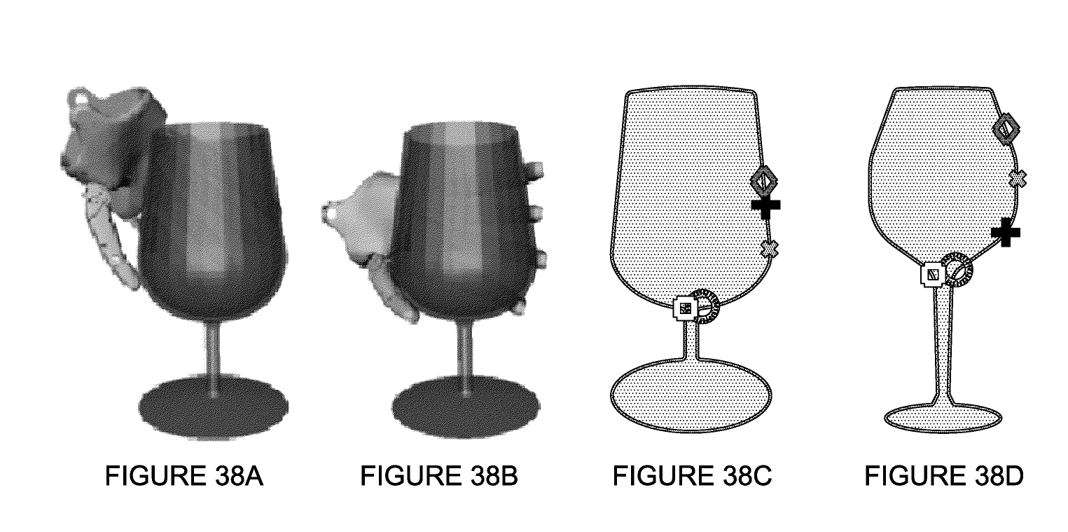

A comparison with a learning algorithm for a five-fingers hand posture is presented at FIGS. 38A-D. In this example, the learning algorithm takes 70,000 iterations before reaching convergence and requires a precise 3D computer-assisted drawing, and the results are substantially the same as the current method, which may use no learning and no optimization. It should be noted that 29,000 iterations gave very poor results on a simple shape such as a wine glass. Thus, it will likely take a lot longer on a more complex object.

Furthermore, the example implementation of the present method yields the same result even with a different wine glass (see FIGS. 38C and 38D), which is substantially similar to the 70,000 iterations and 143 seconds of optimization required by the learning algorithm. This is a surprising result as the present method does not require any iteration, any learning or any simulated environment with perfectly shaped objects, in contrast with the learning algorithm. In some embodiments, the present method takes in average 1.4 s in Matlab® for an object that fits in a 200×200 matrix (100 times faster than the learning algorithm). By using a compiled language like C++ with convolution libraries, the code may be significantly faster and may be implemented in real-time.

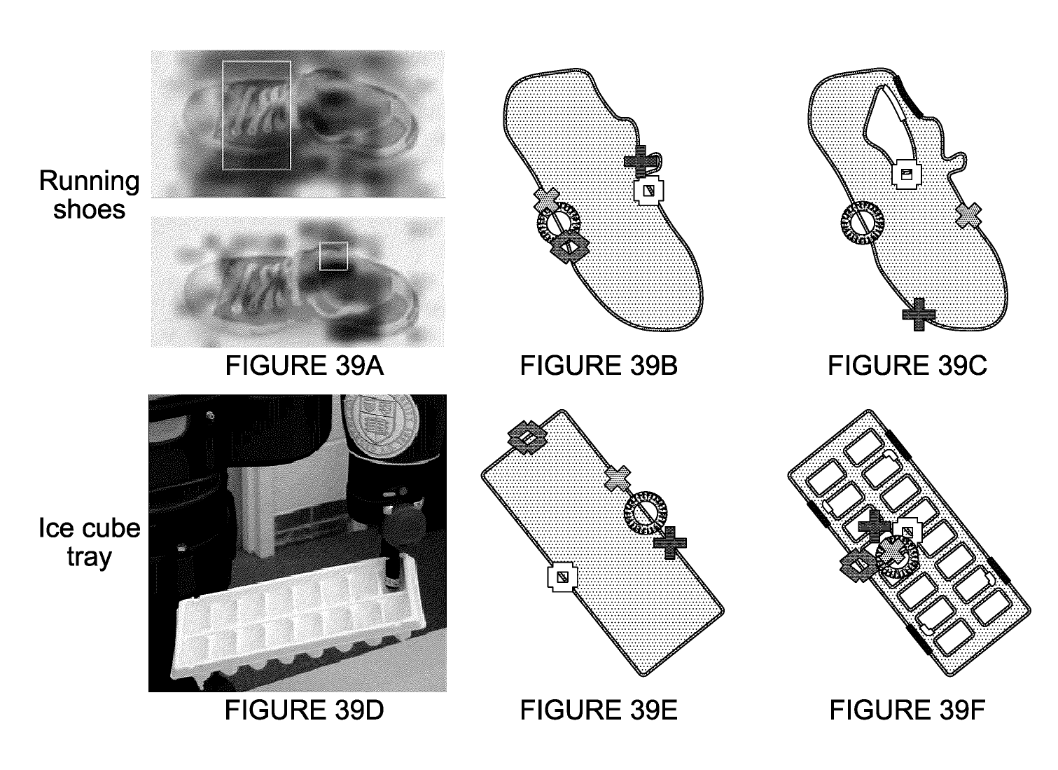

Other learning algorithms are based on deep learning to allow detection of the best grasping regions. These methods were tested on basic two-finger grippers that find a grasping region without finding the most optimal and stable way to grasp an object, which allows objects to be grasped from the inside. This comparison is illustrated in FIGS. 39A-F, with running shoes and an ice cube tray as example objects. FIGS. 39A and 39D illustrate results obtained using the deep learning technique. FIGS. 39B and 39E are the results obtained using the present method on the two objects without holes. FIGS. 39C and 39F are the results obtained using the present method on the two objects with holes.

When using deep learning, while a thin enough region to grasp is found, no stable grasp is found because the technique favors regions that are far from the CM. The results from the present method are superior to those of the deep learning algorithm because the shoe with a hole is grasped closer to the CM, while it grasps directly at the CM for the ice cube tray. Also, the present method allows to find an optimal multi-finger grasp, while the deep network only works with two fingers placed as pincers. Finally, the deep learning method uses a Matlab® implementation that requires 13.5 s/image, which is about ten times slower than an example average of 1.4 s/image obtained with an embodiment of the present method.

In some embodiments, images used with the current method comprise at least two pixels in width for important parts of the object, excluding the corners. In some embodiments, three or more pixels in width is used.

In some embodiments, finger size is considered. For example, this may be done by using a circular shape to size the fingers on the initial image. This will allow any area too small for the robot finger to be removed.

In some embodiments, the size of the grasping hand is considered by reducing the radius of the initial electromagnetic kernels to the size of the grasping hand. To avoid discontinuities in the potential and the field, the values of the potential filter must be shifted so that the boundaries of the kernel are 0.

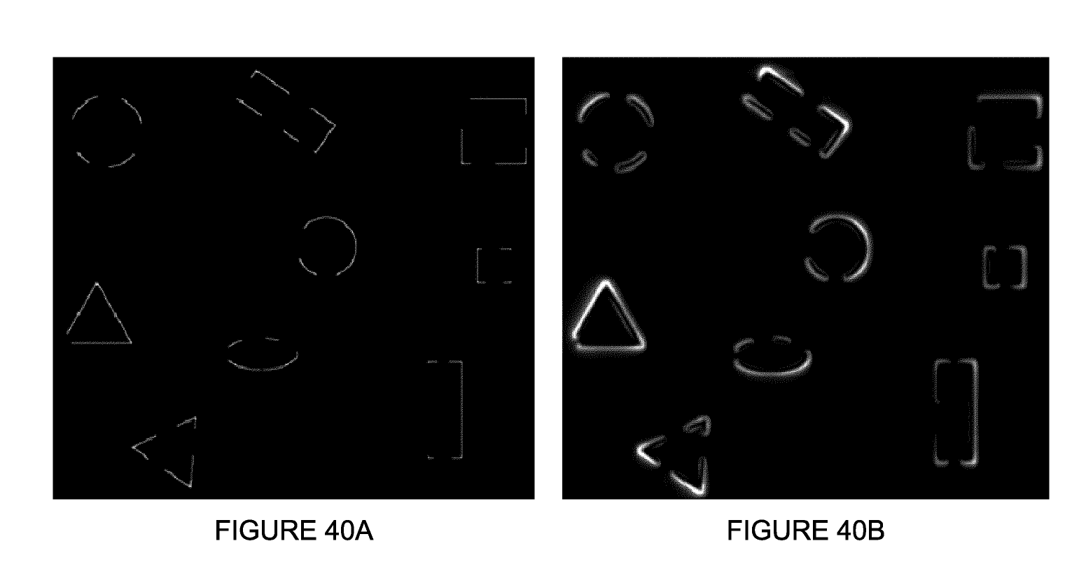

In some embodiments, electromagnetic properties may also be used for defining contours of objects in images. For example, the electrical field may be used to determine an approximate Normal on a curve and to distinguish between the inside of the object (lower electrical field) and the outside of the object (higher electrical field). An example is shown in FIGS. 40A and 40B, where the original image is shown next to the image with electric fields applied.

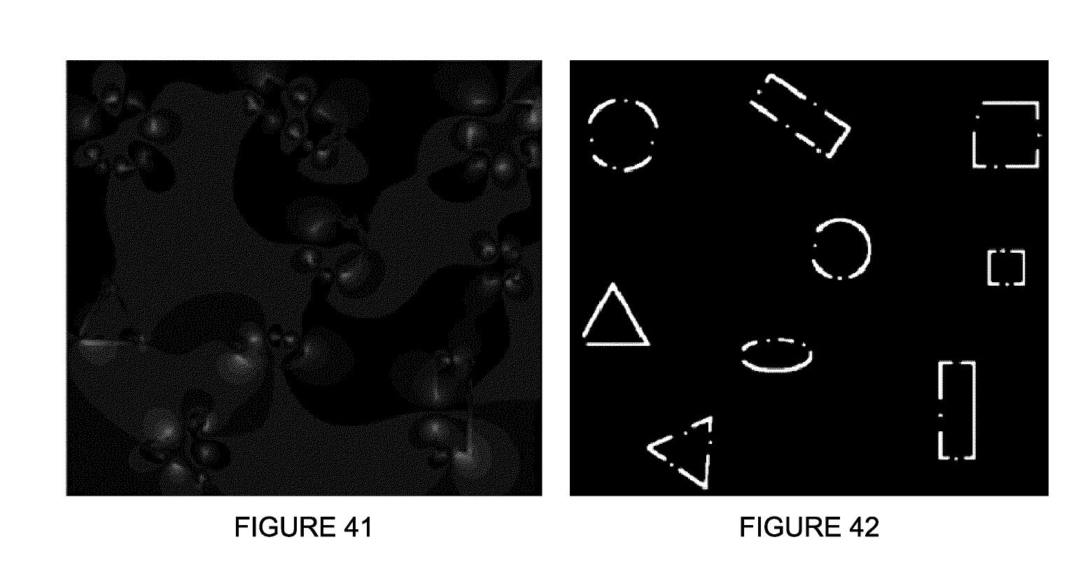

Image convolution performed using magnetic dipole potentials perpendicular to the electric fields causes dipoles to become aligned along the trajectory of the contour, as illustrated in FIG. 41. Serial dipoles cancel out, except in the extremities. The right hand rule provides a direction for regions that are external to the contours while the left hand rule provides a direction for regions internal to the contours, which ensures that dipoles on a same contour will add-up instead of canceling out. In addition, image convolution performed using magnetic dipole potentials parallel to the electric fields allows a distinction to be made between the inside and the outside of an object.

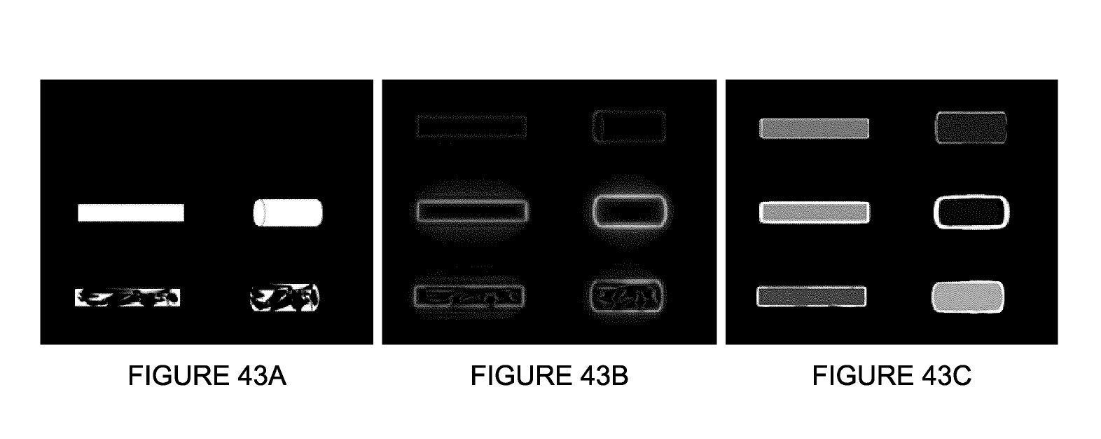

Apertures in an image may be found using the attraction between different dipoles. Indeed, the magnetic potential will be high only where the contours are broken or where there is an abrupt change in direction. By using the electric field and its derivative, it becomes possible to find the position where there is an attraction between dipoles, which is indicative of a hole to fill in the image. The method may then be used iteratively to progressively fill the holes in the image. An example is shown in FIG. 42.

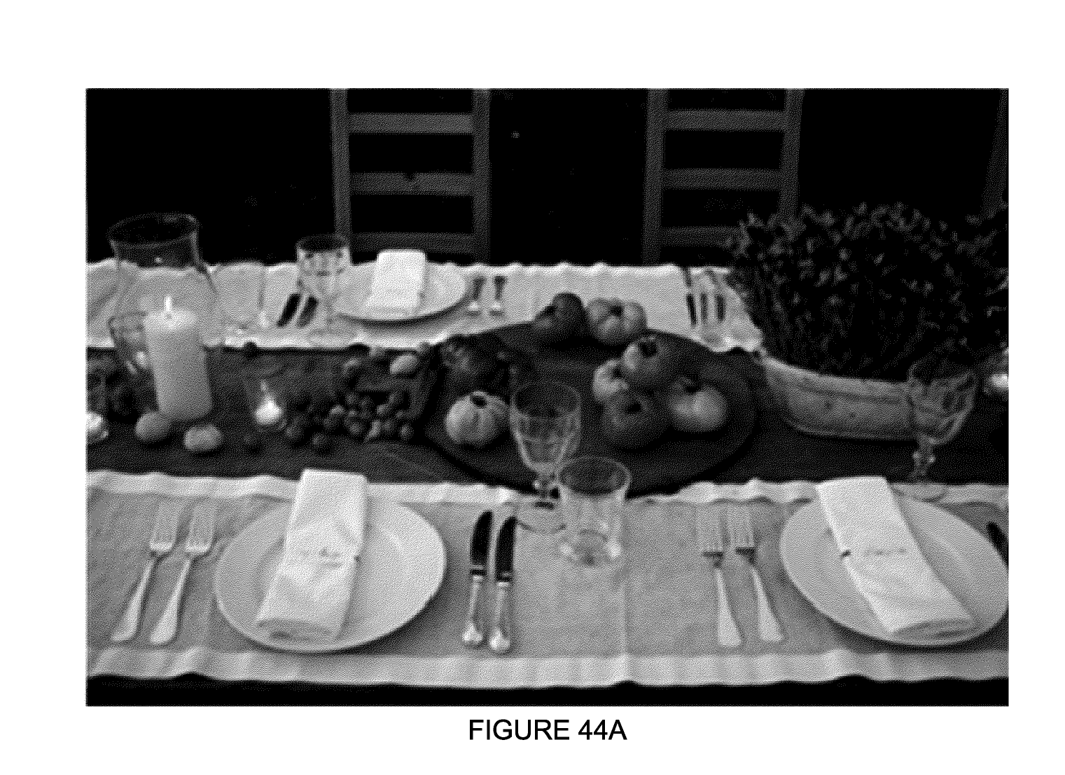

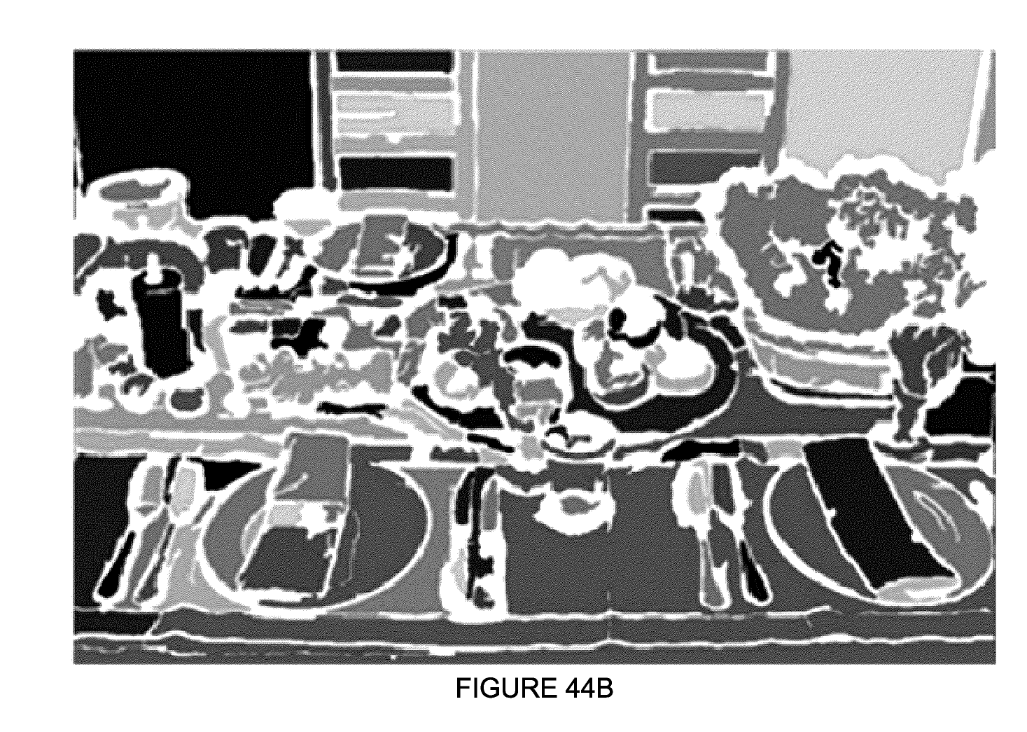

In some embodiments, electromagnetic properties may also be used for image segmentation. For example, using electric charges on segmentation points, the electric fields may be calculated to find the outer area of a grouping of points. Broken contours may also be identified by using some of the principles listed above for defining contours. Broken contours may be reconstructed using edge detection techniques, such as Canny, or using morphological techniques. Object detection may be based on positive energy transfer, i.e. objects are detected when they emit more electric field than they receive. Examples are shown in FIGS. 43A-C. Finally, various elements may be used as charged particles, such as contours, textures, and/or colors. Examples are shown in FIGS. 44A-B.

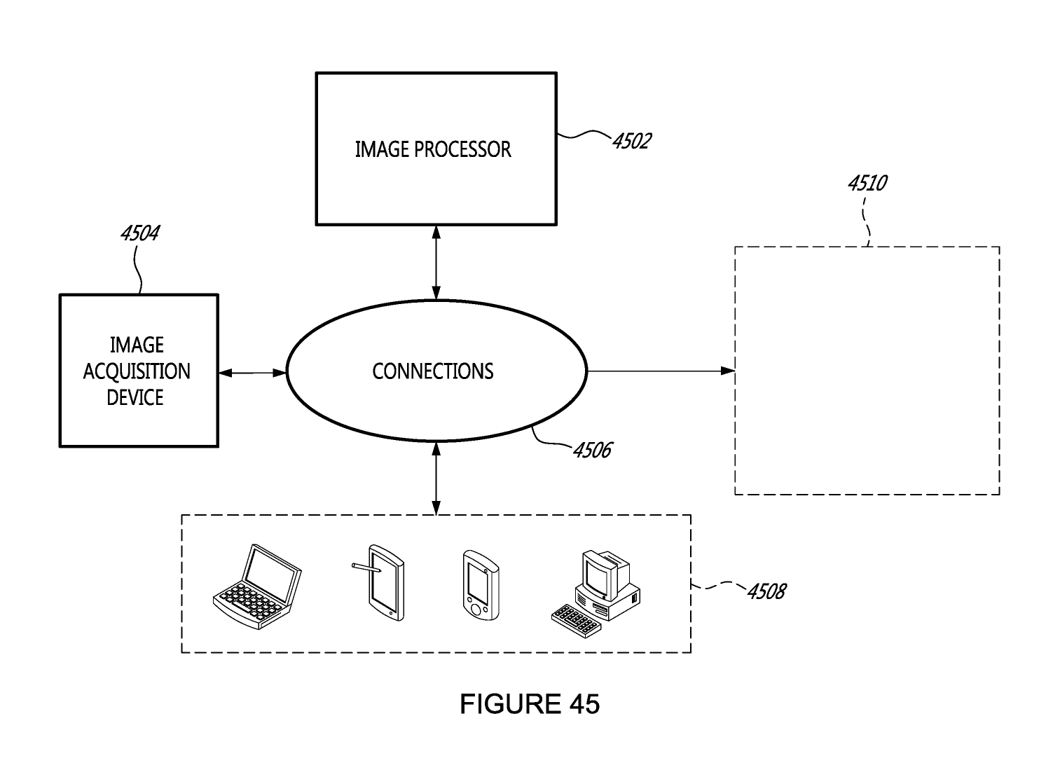

Referring to FIG. 45, there is illustrated an example of an image analysis system for implementing the methods described herein. An image processor 4502 is operatively connected to an image acquisition device 4504. The image acquisition device 4504 may be provided separately from or incorporated within the image processor 4502. For example, the image processor 4502 may be integrated with the image acquisition device 4504 either as a downloaded software application, a firmware application, or a combination thereof. The image acquisition device 4504 may be any instrument capable of recording images that can be stored directly, transmitted to another location, or both. These images may be still photographs or moving images such as videos or movies.

Various types of connections 4506 may be provided to allow the image processor 4502 to communicate with the image acquisition device 4504. For example, the connections 4506 may comprise wire-based technology, such as electrical wires or cables, and/or optical fibers. The connections 4506 may also be wireless, such as RF, infrared, Wi-Fi, Bluetooth, and others. Connections 4506 may therefore comprise a network, such as the Internet, the Public Switch Telephone Network (PSTN), a cellular network, or others known to those skilled in the art. Communication over the network may occur using any known communication protocols that enable devices within a computer network to exchange information. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), and Ethernet. In some embodiments, the connections 4506 may comprise a programmable controller to act as an intermediary between the image processor 4502 and the image acquisition device 4504.

The image processor 4502 may be accessible remotely from any one of a plurality of devices 4508 over connections 4506. The devices 4508 may comprise any device, such as a personal computer, a tablet, a smart phone, or the like, which is configured to communicate over the connections 4506. In some embodiments, the image processor 4502 may itself be provided directly on one of the devices 4508, either as a downloaded software application, a firmware application, or a combination thereof. Similarly, the image acquisition device 4504 may be integrated with one of the device 4508. In some embodiments, the image acquisition device 4504 and the image processor 4502 are both provided directly on one of devices 4508, either as a downloaded software application, a firmware application, or a combination thereof.

One or more databases 4510 may be integrated directly into the image processor 4502 or any one of the devices 4508, or may be provided separately therefrom (as illustrated). In the case of a remote access to the databases 4510, access may occur via connections 4506 taking the form of any type of network, as indicated above. The various databases 4510 described herein may be provided as collections of data or information organized for rapid search and retrieval by a computer. The databases 4510 may be structured to facilitate storage, retrieval, modification, and deletion of data in conjunction with various data-processing operations. The databases 4510 may be any organization of data on a data storage medium, such as one or more servers or long term data storage devices. The databases 4510 illustratively have stored therein any one of acquired images, segmented images, object contours, grasping positions, electric potentials, electric fields, magnetic potentials, geometric features, and thresholds.

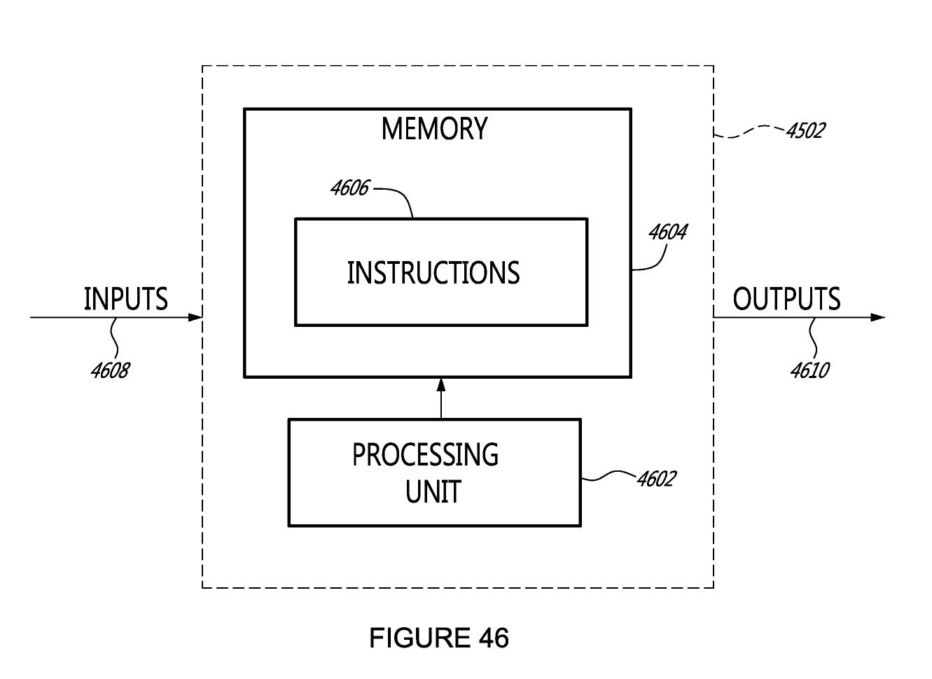

FIG. 46 illustrates an example embodiment for the image processor 4502, comprising a processing unit 4602 and a memory 4604 which has stored therein computer-executable instructions 4606. The processing unit 4602 may comprise any suitable devices configured to cause a series of steps to be performed so as to implement the methods described herein. The processing unit 4602 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 4604 may comprise any suitable known or other machine-readable storage medium. The memory 4604 may comprise non-transitory computer readable storage medium such as, for example, but not limited to, an electronic, magnetic, optical, electromagnetic, infrared, or semiconductor system, apparatus, or device, or any suitable combination of the foregoing. The memory 4604 may include a suitable combination of any type of computer memory that is located either internally or externally, such as random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory may comprise any storage means (e.g., devices) suitable for retrievably storing machine-readable instructions executable by processing unit.

The methods and systems for image analysis described herein may be implemented in a high level procedural or object oriented programming or scripting language, or a combination thereof, to communicate with or assist in the operation of a computer system. Alternatively, the methods and systems described herein may be implemented in assembly or machine language. The language may be a compiled or interpreted language. The program code may be readable by a general or special-purpose programmable computer for configuring and operating the computer when the storage media or device is read by the computer to perform the procedures described herein. Embodiments of the methods and systems for image analysis described herein may also be considered to be implemented by way of a non-transitory computer-readable storage medium having a computer program stored thereon. The computer program may comprise computer-readable instructions which cause a computer to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

Various aspects of the methods and systems for image analysis disclosed herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, changes and modifications may be made. The scope of the following claims should not be limited by the embodiments set forth in the examples, but should be given the broadest reasonable interpretation consistent with the description as a whole.

1. A method for analyzing a shape of an object in an image, the method comprising:
obtaining an image comprising an object;
convoluting the image with a kernel matrix of electric potentials to obtain a total potential image, each matrix element in the kernel matrix having a value corresponding to for a |r|²⁻ⁿ, for n≠2 and ln|r| for n=2, where r is a Euclidean distance between a center of the kernel matrix and the matrix element, and n is a number of virtual spatial dimensions, the total potential image resulting from the convolution and having electric potential values at each pixel position;
calculating electric field values of each pixel position from the electric potential values; and
identifying features of the object based on the electric field values and the electric potential values.

2. The method of claim 1, further comprising representing each pixel position in the image with a density of charge value.

3. The method of claim 1, wherein calculating the electric field values comprises calculating horizontal electric field values and vertical electric field values, and determining normalized electric field and direction values from the horizontal electric field values and vertical electric field values.

4. The method of claim 1, wherein the kernel matrix has a size of (2N+1) by (2M+1), where N and M are a length and a width of the image, respectively.

5. The method of claim 1, wherein calculating electric field values comprises determining a gradient for each pixel position of the total potential image.

6. The method of claim 1, wherein identifying features of the object based on the electric field values and the electric potential values comprises comparing the electric field values to the electric potential values and determining at least one of the features based on the comparing.

7. The method of claim 1, wherein identifying features of the object comprises identifying a shape of at least one region of the object.

8. The method of claim 7, wherein identifying a shape comprises determining whether the at least one region is substantially concave, convex, or flat.

9. The method of claim 1, wherein identifying features of the object comprises identifying a contour of the object.

10. The method of claim 1, wherein the features of the object are one of two-dimensional and three-dimensional features.

11. A system for analyzing a shape of an object in an image, the system comprising:
a processing unit; and
a non-transitory computer-readable memory having stored thereon program instructions executable by the processing unit for:
obtaining an image comprising an object;
convoluting the image with a kernel matrix of electric potentials to obtain a total potential image, each matrix element in the kernel matrix having a value corresponding to for |r|²⁻ⁿ, for n≠2 and ln|r| for n=2, where r is a Euclidean distance between a center of the kernel matrix and the matrix element, and n is a number of virtual spatial dimensions, the total potential image resulting from the convolution and having electric potential values at each pixel position;
calculating electric field values of each pixel position from the electric potential values; and
identifying features of the object based on the electric field values and the electric potential values.

12. The system of claim 11, wherein the program instructions are further executable for representing each pixel position in the image with a density of charge value.

13. The system of claim 11, wherein calculating the electric field values comprises calculating horizontal electric field values and vertical electric field values, and determining normalized electric field and direction values from the horizontal electric field values and vertical electric field values.

14. The system of claim 11, wherein the kernel matrix has a size of (2N+1) by (2M+1), where N and M are a length and a width of the image, respectively.

15. The system of claim 11, wherein calculating electric field values comprises determining a gradient for each pixel position of the total potential image.

16. The system of claim 11, wherein identifying features of the object based on the electric field values and the electric potential values comprises comparing the electric field values to the electric potential values and determining at least one of the features based on the comparing.

17. The system of claim 11, wherein identifying features of the object comprises identifying a shape of at least one region of the object.

18. The system of claim 17, wherein identifying a shape comprises determining whether the at least one region is substantially concave, convex, or flat.

19. The system of claim 11, wherein identifying features of the object comprises identifying a contour of the object.

20. The system of claim 11, wherein the features of the object are one of two-dimensional and three-dimensional features.

21-40. (canceled)
